(19) United States
(12) Patent Application Publication
(10) Pub. No.: US 2016/0004515 A1
(43) Pub. Date: Jan. 7, 2016

(54) METHOD FOR PROVIDING APPLICATION DEVELOPMENT ENVIRONMENT AND DEVICE

(71) Applicant: NEXDIGM CO., LTD., Anyang-si, Gyeonggi-do (KR)

(72) Inventors: Guk Sil Baeck, San Jose, CA (US); Yong Ho Kim, San Jose, CA (US)

(21) Appl. No.: 14/762,199

(22) PCT Filed: Jan. 21, 2014
(86) PCT No.: PCT/KR2014/000572

§ 371 Date: Sep. 15, 2015

(30) Foreign Application Priority Data
Jan. 22, 2013 (KR) 10-2013-0007167
Jan. 22, 2013 (KR) 10-2013-0007170

(51) Int. Cl. G06F 9/44; G06F 9/45; G06F 3/0481

(52) U.S. Cl. CPC G06F 8/30; G06F 3/0481; G06F 8/41

(57) ABSTRACT

A method for providing an application development environment according to one embodiment of the present invention comprises the steps of: displaying a first screen showing a connection relationship among a plurality of pages forming an application; and displaying a second screen showing a connection relationship among a plurality of components for any one of the plurality of pages, wherein the first component containing event information is connected to a second component containing action information on the second screen.

### CROSS-REFERENCE TO RELATED APPLICATIONS

The present utility application is the National Phase filing under 35 U.S.C. 371 of the Korean Application No.: 10-2013-0007167, filed 22 Jan. 2013, 1020130007170, filed 22 Jan. 2013 and International Application No.: PCT/KR2014/000572, entitled “METHOD FOR PROVIDING APPLICATION DEVELOPMENT ENVIRONMENT AND DEVICE”, filed 2014 Jan. 21.

### RELATED CO-PENDING U.S. PATENT APPLICATIONS

No applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

The present invention relates to a method for providing an application development environment and an apparatus for the same, and more particularly to a method and an apparatus for providing an application development environment to improve the development efficiency of an application developer.

Recently, as a variety of terminal devices such as a smart phone or tablet PC are attaining popularity, interests in the application that can be used with these terminal devices have been increased.

In particular, in recent days, when a developer develops and uploads an application on an application store, a system for the users to purchase and download the application of their choice and by accessing the application store using a communication device has been widely used. Accordingly, a number of applications are being developed actively in various fields.

To this end, in order to develop applications actively, in general, the experts of C language, JAVA, OBDC, SQL, etc., are conducting coding and development activities directly.

FIG. 1 is a view showing a typical environment for application development.

As shown in FIG. 1, a typical application development procedure comprises declaring such widgets as Activity, Dialog, Frame, etc., for stepwise matching by individual event or window message and implementing the event procedures which inherit them using predetermined codes.

However, these developing procedures can be accessed only by experienced developers, and require special knowledge of the language described above. In addition, a developer has to implement a lot of codes directly through event procedures, which require rich knowledge, time and effort.

Further, when there is a change in the service scenario in the developed code, the developer has to edit a number of codes.

In addition, the difference in the degree of expertise and personal coding styles can cause difficulty in group-based development, compatibility of modules created by different developers, or complexity in the modules according to the degree of understanding in modularization, which may result in serious bugs.

On the other hand, even if a same developer develops applications having the same functions, the development must be performed using different application development tools according to the OS platform in which the application is to be used, which also takes time and cost.

An object of the present invention is to provide a method and apparatus for an application development environment which can improve the development efficiency of a developer.

Another object of the present invention is to provide a method and apparatus for an application development environment which provides a user interface which facilitates scenario control and application development even without special knowledge.

In addition, still another object of the present invention is to provide a method and apparatus for an application development environment which can prevent overlapping development by being able to be adapted to various devices while maintaining compatibility among modules.

The method for providing an application development environment in accordance with the present invention comprises the steps of: displaying a first window showing a connection between a plurality of pages that make up an application; and displaying a second window showing the relationship among a plurality of components corresponding with any one of the plurality of pages, and in the second window, a first component comprising event information and a second component comprising action information are interconnected.

In addition, in an application development environment provided according to an embodiment of the present invention for achieving the above object, the apparatus providing the application development environment comprises a display device which shows a first window showing the connection between a plurality of pages that make up an application, and a second window showing the connection among a plurality of components corresponding with any one of the plurality of the pages, and a controller which performs control to connect a first component comprising event information in the second window and a second component comprising action information.

A method for providing an application development environment in accordance with an embodiment of the present invention to achieve above object comprises the steps of: displaying at least one component defined with an intermediate language on the window; generating a first code consisting of the intermediate language depending on the event or action that is specified in the component; and converting the first code to a second code corresponding to a target platform.

In addition, an apparatus for providing an application development environment according to an embodiment of the present invention for achieving the above object comprises: a display unit for displaying at least one component which is defined by an intermediate language on the window; an intermediate language generation unit for generating a first code consisting of the intermediate language depending on the event or action that is specified in the component; and a conversion unit for converting a first code to a second code corresponding to the target platform.

According to an embodiment of the present invention, when providing an application development environment, the embodiment displays a first window showing a connection relationship between a plurality of pages, and to display the second window showing a connection relationship between the components with correspond to any one of the pages.

In particular, by connecting the first component including event information and a second component including action information, the connection relationship between the components can be expressed in a way easy to understand.

On the other hand, as the modifications to the connection relationship can be implemented by modifying the image objects that represent connection relation between the components. As such, even a developer without sufficient professional knowledge can perform the connection between the components and implement the scenario.

Further, by using such an intermediate language according to an embodiment of the present invention for application development, an application can be converted to another application for another device using a different OS. As a result, a plurality of applications for different OS platforms can be developed by a single development effort.

Further, various user interfaces and functions can be provided to facilitate application development, improving the user convenience of the developers.

### BRIEF DESCRIPTION OF THE DRAWINGS

The figures below will describe and illustrate the waffle box 27 technology. The figures although numbered in progression are grouped in two types. Type I describes about the five (5) side waffle box 27 (FIGS. 1 to 26), while Type II describes about the four (4) or six 6) side waffle boxes 27 with wings 10 (FIGS. 27 to 56).

FIG. 1 shows a typical application development window.

FIG. 2 is a schematic diagram showing an example of the overall development system including an application development environment provider according to an embodiment of the present invention.

FIGS. 3 through 6 are views for explaining the method for providing an application development environment according to an embodiment of the present invention.

FIG. 7 is a view showing the relationship between the second window and the actual code in the embodiment.

FIG. 8 is a view for explaining the action list in the second window 120 in accordance with an embodiment of the present invention.

FIG. 9 is a block diagram showing the components and connection between the display method of the application development environment providing apparatus 100 according to another embodiment of the present invention.

FIG. 10 is a view for explaining how to add the components of the application development environment provider to the application development environment providing apparatus 100 according to an embodiment of the present invention.

FIG. 11 shows a data binding method of providing an application development environment providing apparatus 100 according to an embodiment of the present invention.

FIG. 12 shows a relational database management system (RDBMS) providing a method of setting an application development environment providing apparatus 100 according to an embodiment of the present invention.

FIG. 13 shows an open API type data setting method of providing an application development environment providing apparatus 100 according to an embodiment of the present invention.

FIG. 14 shows a specialized Restful/SOAP setting of the application development environment providing apparatus 100 according to an embodiment of the present invention.

FIGS. 15 through 24 are views for explaining a method for providing an application development environment according to another embodiment of the present invention.

FIG. 25 shows a window in which an application developed by an application development environment providing apparatus 100 is converted to a second language executable in the target terminal 300.

FIGS. 26 and 27 show a component deployment method of a second window provided by the application development environment providing apparatus 100 according to another embodiment of the present invention.

FIG. 28 shows a layout method of the application development environment providing apparatus 100 according to another embodiment of the present invention.

FIGS. 28 to 30 show the embodiments of the block layout.

FIG. 31 is a schematic block diagram showing a platform of the application development environment providing apparatus 100, FIG. 32 is a schematic block diagram showing the platform of a terminal 300 which can run the application, and FIG. 33 is a block diagram showing the architecture of a server 300.

FIG. 34 shows a structure of the components according to an embodiment of the present invention.

FIGS. 35 to 52 are the drawings referred to describe the process of creating an application using the windows provided in accordance with the service application development environment according to an embodiment of the present invention.

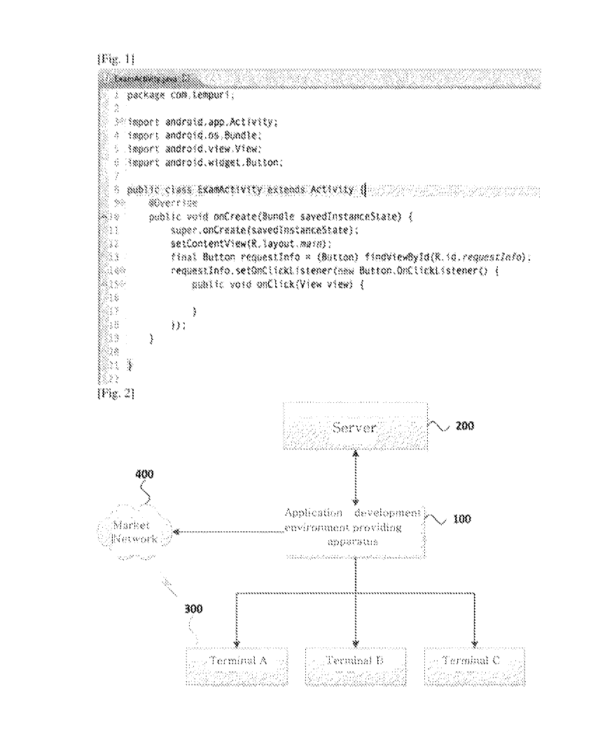

### DETAILED DESCRIPTION OF SOME OF THE EMBODIMENTS

The description below only exemplifies the principle of the present invention. Therefore, although one of ordinary skills in the art that will embody the principles of the present invention, although not shown or described explicitly herein, and the invention can be a variety of devices included in the spirit and scope of the invention. In addition, all of the conditional terms and embodiments listed herein are, in principle, and the concept of the present invention to such understanding is clearly intended to be understood as not limited to the particular embodiments and conditions described.

In addition, the principles of the present invention, aspects and embodiments, as well as all the description listing the particular embodiments should so understood as to be intended to include structural and functional equivalents of such information. It should also be understood to include all devices invented to perform the same function, regardless of the structure to be such equivalents that are currently known, as well as those equivalents to be developed in the future.

Thus, for example, the block diagrams in the specification should be so understood as representing a conceptual viewpoint of an exemplary circuit that embodies the principles of the invention. Similarly, all the flow charts, state conversion chart, such as the pseudo-code should be so understood that whether or not to represent various processes performed by a computer or processor that can be substantially represented in computer readable medium and a computer or processor.

The functions of various elements shown in the drawings, including functional blocks labeled as a processor or a similar concept can be provided through the use of hardware that has the capability of executing software in association with appropriate software as well as dedicated hardware. When provided by a processor, the functions may be provided by a single dedicated processor, single shared processor, or a plurality of individual processors, some of which may be shared.

The processor, specific use of the terms set forth by the control or a similar concept should not be interpreted as incorporated by exclusive hardware that has the capability of executing software, a digital signal processor (DSP) hardware, without limitation, ROM for storing software, it should be understood to include random access memory (RAM) and non-volatile memory devices implicitly. It may also include other hardware generally known.

In the claims of this application, the components expressed as means for performing the functions described in the description include any type of software, including for example, a combination or firmware/microcode, etc. of circuit elements to perform such function. It was intended to include all methods for performing the functions, which are combined with appropriate circuitry for executing the software to perform the function. Any means that can provide the functionality, so that the present invention is defined by the claims, such that the combined functionality provided by various recited means are combined with the method of claims should be understood to be equal to that identified herein.

The foregoing objects, features and advantages will become more apparent from the following detailed description in conjunction with the accompanying drawings, whereby those skilled in the art will be able to easily implement the invention. In addition, a detailed description thereof will be omitted if it is determined that the description of the present invention, a specific description of the related art and the present invention may unnecessarily obscure the understanding of the subject matter of the present invention.

Hereinafter, preferred embodiments of the present invention will be described in further details with reference to the accompanying drawings.

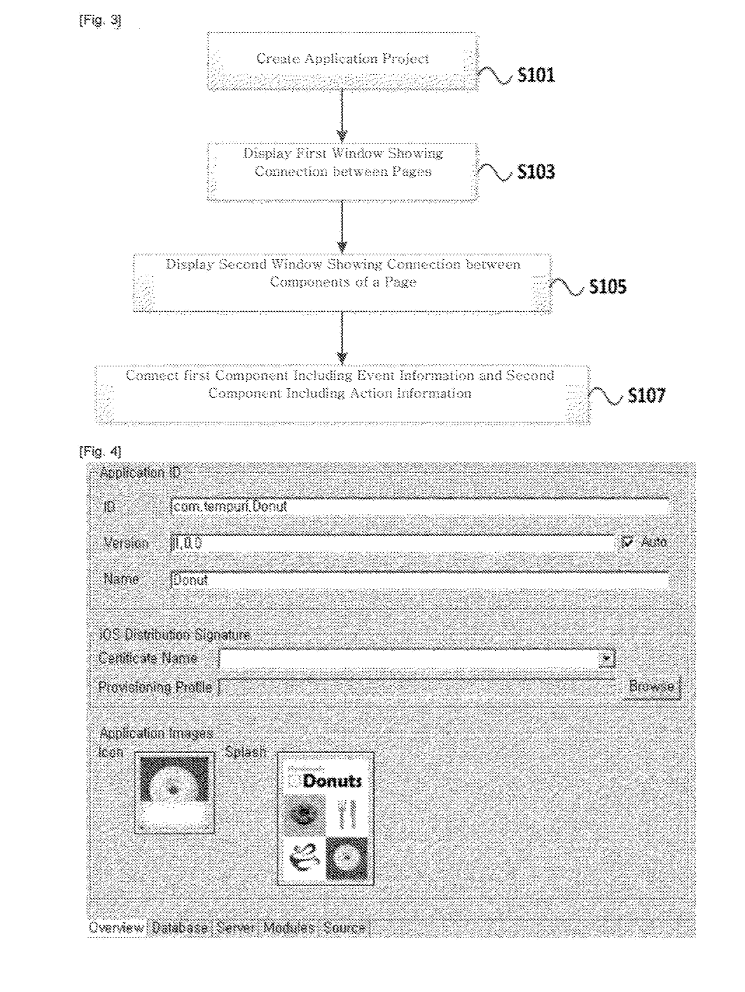

FIG. 2 is a schematic view showing an example of an application development system including an application development environment providing apparatus 100 according to an embodiment of the present invention.

Referring to FIG. 2, the application development system according to an embodiment of the present invention comprises an application development environment providing apparatus 100 for providing an application development environment, a server 200, a terminal 300 and a market network 400.

The application development environment providing apparatus 100 is capable of proving the windows showing the connection between a plurality of the pages constituting the application in accordance with an embodiment of the present invention, and the connection between a plurality of the components with reference to any one of the plurality of pages in an intuitive way.

To this end, the application development environment providing apparatus 100 comprises a display unit which displays a first window showing connection between a plurality of pages that constitute an application, and a second window showing the connection between the plurality of components with reference to any one of the plurality of pages, and a controller which controls to connect the first component comprising event information and the second component comprising action information to be connected in the second window.

Here, an application may refer to the application data which are executed in the application development environment providing apparatus 100 or the terminal 300. In addition, the application data may be generated by an application development environment providing apparatus 100 and may be sent directly to the terminal 300.

In addition, the application data generated can be uploaded to the market network 400, and the uploaded application data can be transmitted to the purchase authenticated terminal 300.

In addition, the application may include a plurality of pages, each page comprising a plurality of components.

An application page may mean an electronic document or graphical user interface which is interpreted as an object and executed by the terminal 300. In addition, a plurality of components included in each page may be structured to form a connection to the components contained in the different pages.

Such a connection relationship can be formed when the event information included in a component is connected with the action information of another component.

More specifically, when the application is executed and an event of a particular component is generated based on the event information, the action of the component can be carried out based on the action information in its associated another component.

Therefore, when the terminal 300 is running an application, it can perform various actions according to the connection relationship between the pages and between the components. And, the developer is able to provide various application services by using this. In particular, according to an embodiment of the present invention, intuitive and simple interface can be provided for forming the connection relationship between the pages and components to reduce the time and efforts for developing applications and enable developing applications without expertise in software programming.

On the other hand, the application development environment providing apparatus 100 may configure an application project generated by the application development environment with intermediate language, and convert the application project or application code composed of intermediate language to adapt to the target platform or OS of the target terminal. In addition, the application development environment providing apparatus 100 may output an application executable on the target device.

In particular, the application development environment providing apparatus 100, in order to solve the problems in the stereo type development patterns and low reusability of codes, may create an application composed of component-based intermediate language. Accordingly, an application developer is able to perform scenario planning, development of server and client simultaneously.

In addition, the application development environment providing apparatus 100 may provide an integrated platform for application development, an interface which can add UX component and a server component development and a template development, and an open platform with which a developer can create and add components easily. Thus, an embodiment of the present invention can provide an application development environment which is centered on the user and product, instead of developer.

On the other hand, the server 200 may be connected to an application development environment providing apparatus 100, and can provide the data and authentication information required by an application development environment providing apparatus 100.

In addition, the server 200 can check the version information of the application development environment providing apparatus 100 and provide it with update service. And, the server 200 may include a database or WAS (Web Application Server) required by an application development environment providing apparatus 100.

In particular, the server 200 may include a component database that can be used in an application development environment providing apparatus 100. And, the server 200 can transmit a pertinent component to an application development environment providing apparatus 100 which has been authorized for purchasing the component. And, the server 200 may comprise a web container for the interpretation of the component.

On the other hand, a terminal 300 may be a terminal which can execute an application generated by the application development environment providing apparatus 100, for example, a smart phone or a tablet PC, and the like.

In particular, the platforms or the OSs of the terminals 300 may be different from each other. Therefore, the application development environment providing apparatus 100 according to the embodiment of the present invention is capable of identifying the target terminal and provides the application to the target terminal composed of intermediate language by converting it in a code executable by the target device, so that the target terminal can receive and execute the converted application. By this, developers can significantly reduce the time and effort to convert the same application in different platforms, without the need for special knowledge on other OSs.

Hereinafter, an application development environment providing method according to an embodiment of the present invention is described by referring to FIGS. 3 to 6.

FIG. 3 is a flowchart illustrating a method of providing an application development environment according to an embodiment of the present invention.

Referring to FIG. 3, firstly, an application development environment providing apparatus 100 generates an application project (S101).

An application development environment providing apparatus 100 may generate an application project for development of an application. An application project may include a variety of information constituting the target application. In addition, the application project may comprise identification information, version information, developer information, authentication information, image information, connection information database connection information, server connection information, module information and source information of the target application, optimized for the target platform.

For this, the application development environment providing apparatus 100 may provide for a window for creating an application project.

FIG. 4 shows an application project creation window provided by the application development environment providing apparatus 100.

Referring to FIG. 4, the developer can create an application project in the project creation window. An application project creation window may include an application identification information (Application ID) input window, authentication information and profile input windows, and application image input window, as shown in FIG. 4. By this, the efforts for inputting information and images can be minimized.

In particular, the application development environment providing apparatus 100 can perform automatic re-sizing and automatic version control of the application pages, when an application project is created and a target platform is defined.

Then, the application development environment providing apparatus 100 displays a first window showing a connection relationship between a plurality of pages (S103).

An application development environment providing apparatus 100 can display the page information of the application being developed by the generated application project through a first window. The first window may indicate connection between pages.

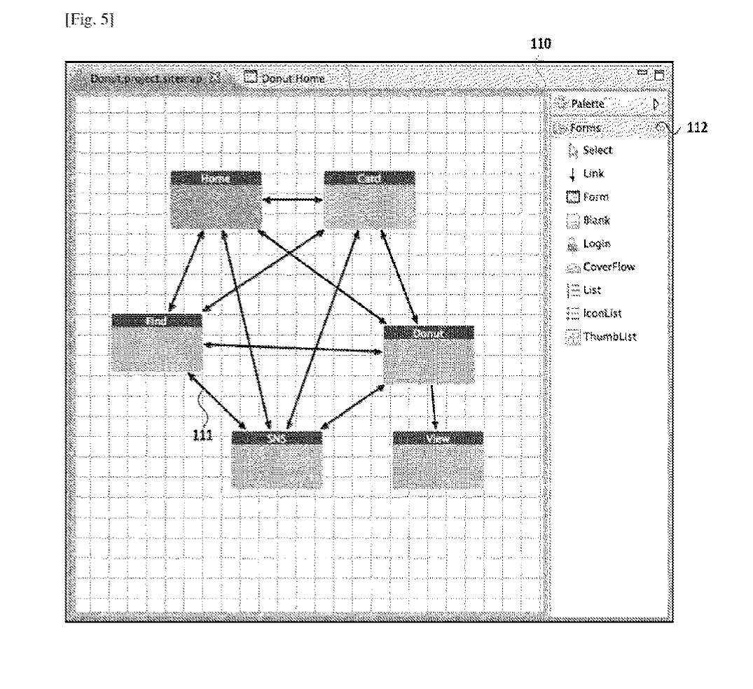

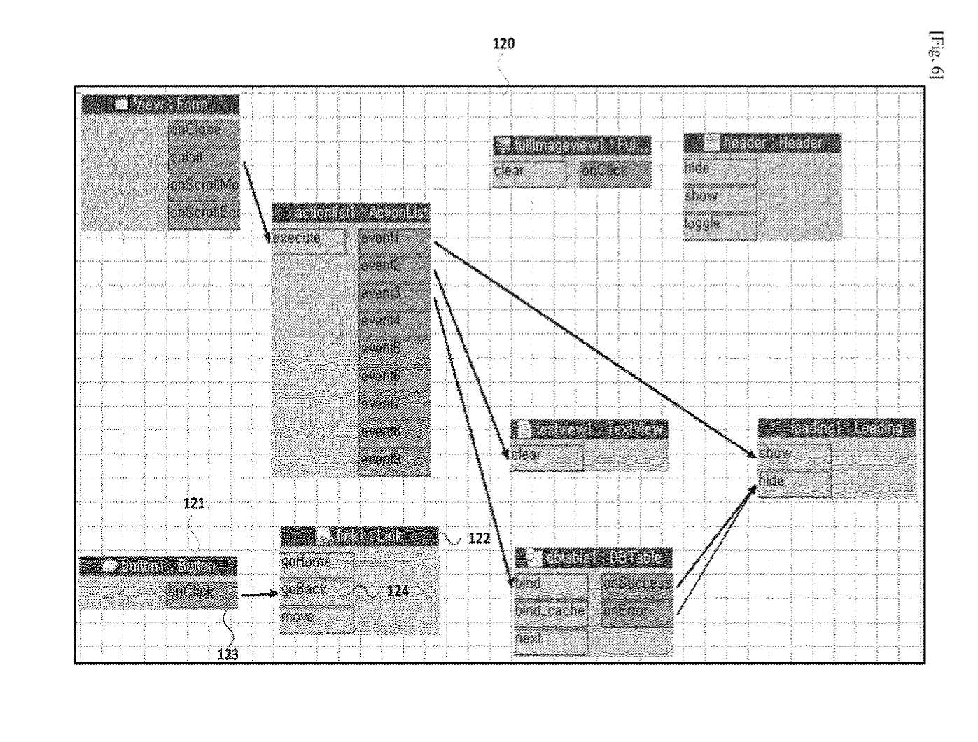

FIG. 5 shows a first window 110 displayed by the application development environment providing apparatus 100.

As shown in FIG. 5, the first window 110 may represent a connection relationship of a plurality of pages to be included in the application under development by the application projects. These pages when an application is executed in a terminal 300 may indicate the respective electronic documents that can be displayed. And an electronic document displayed in the terminal 300 by the application can be switched in accordance with the connection relationship between the respective pages. This switching, or shift can be performed by the event of a component and accompanied action.

For example, as shown in FIG. 5, an applications may comprise a Home page, Card page, Find page, Donut page, the SNS page and View page. The first window 110 may comprise a plurality of arrow images 111 indicating a connection relationship between the respective pages. Each arrow image 111 may represent the relationship between the movement or the switching of the pages.

In particular, an application developer can edit the relationship between the pages by changing or deleting the arrow images 111 displayed in the 1st window 110 as desired. For example, a developer may connect pages by inserting a new arrow, or separate pages by deleting an existing arrow.

And, the application development environment providing apparatus 100, if there is a change or deletion of such an image of an arrow, can reflected it in the application code composed of an intermediate language. Therefore, an application developer can easily identify and edit a connection relationship between pages without special knowledge.

On the other hand, the application development environment providing apparatus 100 may display form tabs 112 to set up connection or adding pages on or around the 1st window 110. The form tab 112, for example, may include pre-defined icons for further connection between setting and page.

And, each of the icons can be moved by drag and drop, and when moved to the first window 110, the application development environment providing apparatus 100 can set up connection relationship or add a predefined page.

FIG. 3 will be described again.

Then, the application development environment providing apparatus 100 displays a second window showing a connection relationship between the components with respect to a page (S105). And, the application development environment providing apparatus 100 connects a first component including event information and a second component including action information (S107).

As described above, a page may comprise a plurality of components. Each component may refer to a unit object that is responsible for a window or function on the page. And, the components may include event information or action information to take care of such a window or function.

The event information may include user input preset for a terminal 300 or an event generated by the operation of the terminal 300. For example, the events may comprise onClose, onInit, onScrollMouse, onClick, onError, onSuccess or onEnd event.

And, each event can correspond to action information in other components. Action information may comprise information about the operation of the application which is performed according to the event generated by the terminal 300. For example, operation of the application performed depending on the event may include execution of a specific component, hide, show, toggle, page shift, clear command, goHome command, goBack command, bind command or next command.

As such, event information or action information contained in each component may correspond together, respectively, and the corresponding relationship can be displayed on the second window.

FIG. 6 shows a second window 120 according to an embodiment of the present invention.

As shown in FIG. 6, the second window 120 may represent each of the components, may indicate connection relationship between the event information and action information included in the respective component.

In particular, each component may be in the form of individual blocks in the second window 120. And, the action information contained in each component may be displayed in the form of a text box on one side of the block, with event information displayed as a text box on the opposite side of the block.

And, the connection relationship between each box can be displayed by an arrow image. Each arrow image can be started from a particular event of a particular component, and may be directed to a specific action of the other components. In this case, the image of an arrow may indicate the action of the component to be executed next when a specific event occurs.

In the same manner as previously described regarding the first window 110, an application developer can change or delete the image of each arrow in the second window 120, and can add or remove each component by drag and drop. Accordingly, the connection relationship between the events and actions of the respective components can be changed, and the application development environment providing apparatus 100 can generate or delete the application code composed of intermediate language according to the change of the component and arrow displayed on the second window 120.

For example, button1 component block 121 may include onClick event box (123), and onClick event box 123 can be connected to goBack 124 action box included in link1 component block 122 by an arrow image. In this case, the application development environment providing apparatus 100 may generate a code with intermediate language and insert it in an application code being developed so that, at generation of onClink even with respect to button1 component, goBack action of link1 component can be executed. Therefore, a developer can create connection relation between components using the user interface without knowledge on the code.

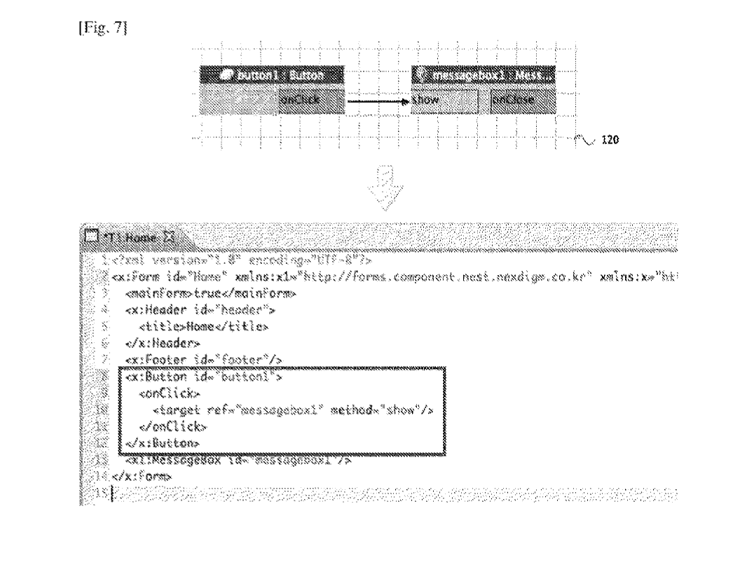

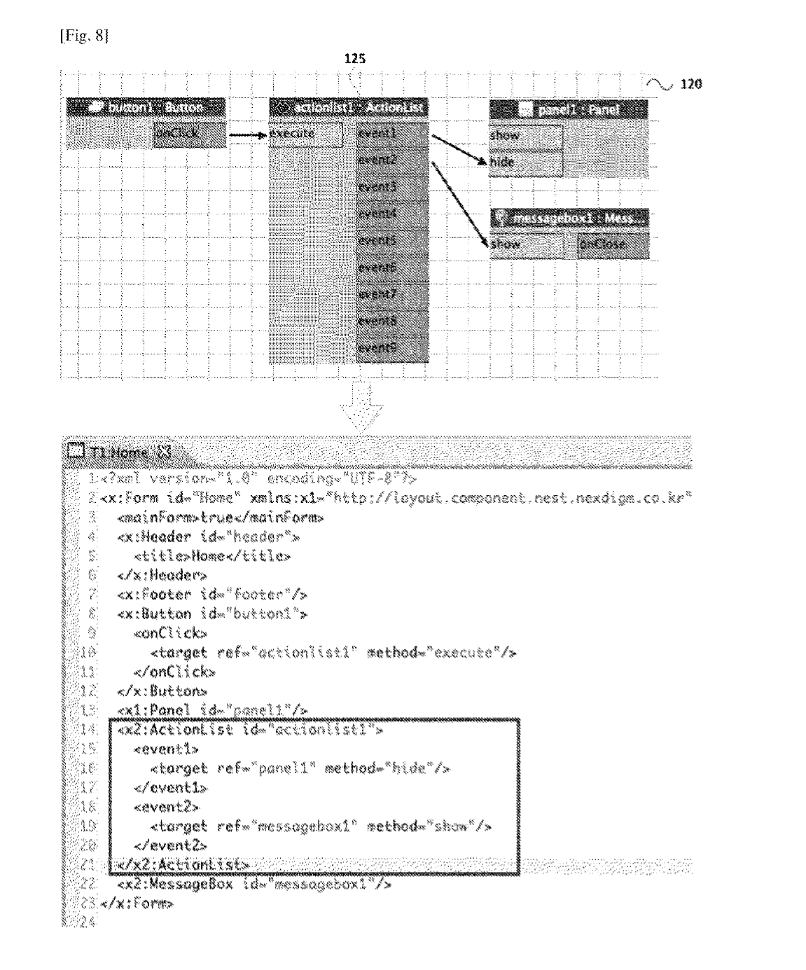

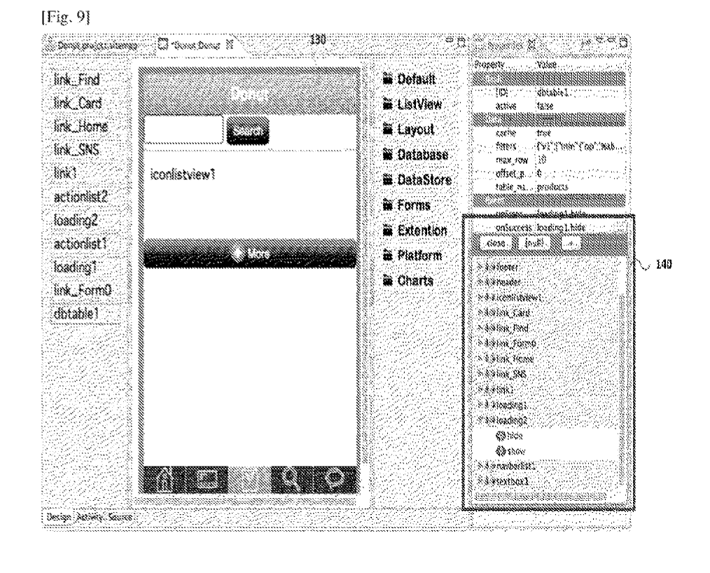

FIG. 7 is a view showing the relationship between the second window and the actual code in accordance with an embodiment of the present invention.

As shown in FIG. 7, an application developer can, in case of an onClick event of Button1 component, can designate the messagebox1 component to be executed next and the show which is the action included in the component by connecting them with an arrow image in the second window 120. In this case, the application development environment providing apparatus 100 can automatically create the code in the box at the bottom of FIG. 7 and insert it in the application code. Therefore, a developer can set up connection between desired event of action of a component using user interface only, without implementing the connection relationship between the event and action using JAVA coding.

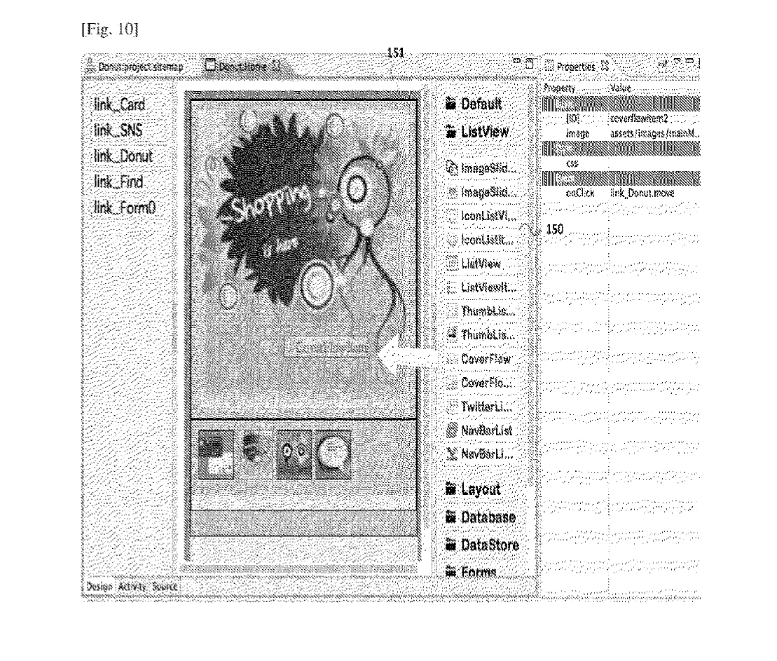

FIG. 8 is a view for explaining the action list in the second window 120 in accordance with an embodiment of the present invention.

Referring to FIG. 8, the application development environment providing apparatus 100 may represent a one-to-one relationship between an event and an action by the arrow images in the second window 120, which has a limitation in executing a plurality of actions in response to a single event.

To this end, in accordance with an embodiment of the present invention, to solve this problem the second window 120 may further include an action list component block 125. The action block list component 125 may represent an intermediate component which is interposed in the component to perform a number of actions in response to an event.

For example, a developer can create an action list component block 125, and generate connection relationship by connecting with arrows so that a plurality of execute actions of the action list component block 125 can be executed in response to a single onClick event to generate a plurality of events (event 1˜event 9). In addition, the developer can designate the components and actions to be executed by a plurality of events (event1˜event9) again using arrow images. In FIG. 8, hide action of panel1 component is executed corresponding with event1, and show action of messagebox1 is executed corresponding with event2.

In addition, the application development environment providing apparatus 100 can generate a code composed of intermediate language which enables the connection relationship set up in the second window 120 executed in the application, as shown in the bottom of FIG. 8.

Accordingly, when the application runs on the device 300, by the connection relationship set in the second window 120, when a user clicks the Button1, the panel1 is hidden and the messagebox1 is shown.

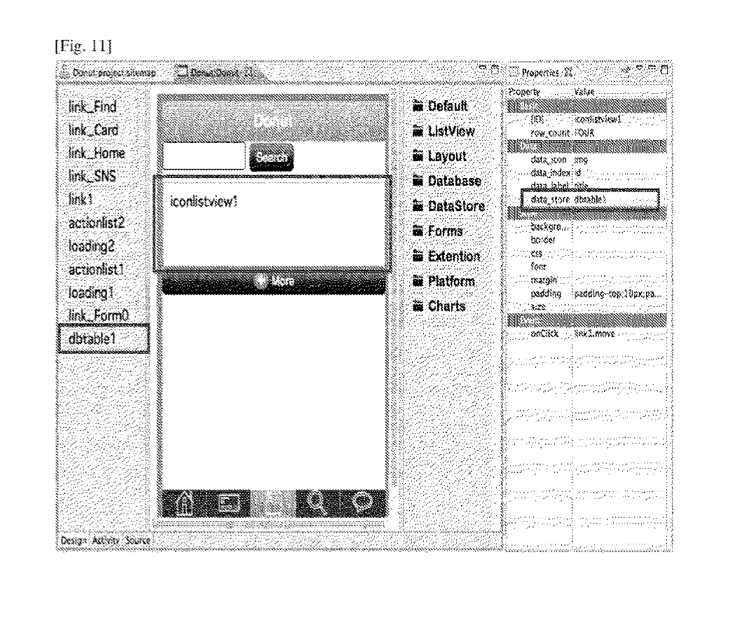

FIG. 9 shows a method for displaying the component blocks and their interconnections of the application development environment providing apparatus 100 according to another embodiment of the present invention.

Referring to FIG. 9, the application development environment providing apparatus 100 may display a page window 130 and a component block 140 window showing the components the blocks contained the page.

The page window 130 may represent a page image implemented by the respective components.

And, the component block window 140 may represent a connection between the component and the events and actions in a tree structure. Each component may be represented by 1 depth, and in lower depth, the actions included in the component are located. Accordingly, the developer can easily select the desired components and actions.

And, the attribute information of the selected component or actions may be shown at the top of the component block window 140. Attribute information may include the identification information, data connection information and event information associated with each action of the individual components.

Note that the component block window 140 and the page display window 130 may correspond to the second window 120 described above. Thus, the application development environment providing apparatus 100 can display an application in the second window 120, or selectively in the component block window 140 and page window 130. To this end, the application development environment providing apparatus 100 may provide a setting menu for the display method of the connection between components.

This method of connection between the event and the action, unlike the method using the event handling procedure using double click and procedure generation of conventional development environment, can be a method for selecting event and action to be included in a components. Therefore, when a specific button is pressed, the developer can simply select a component object and action included in the cont to be executed to complete connection between event and action.

FIG. 10 shows a method for the application development environment providing apparatus 100 adding components according to an embodiment of the present invention.

Referring to FIG. 10, the application development environment providing apparatus 100 may display a list 150 of predefined components that can be added to page window 151. And, the component list 150 may include a plurality of component items. Each component item may be associated with each component code having a predefined function or display window.

In addition, the developer can select any of the items in this component to move to the page window 151 by drag and drop. In response to this, the application development environment providing apparatus 100 can facilitate adding components by inserting a code corresponding to the relocated component item in the application code. Therefore, a developer can add components to a page with simple drag-and-drop without writing code for the component.

In addition, pre-defined components can be received and updated from a server 200. An application development environment providing apparatus 100 can communicate with the server 200 to receive new components, and update the list of the components. The developer can add new components to the application page by drag and drop from the updated components list.

FIG. 11 shows a data binding method of an application development environment providing apparatus 100 according to an embodiment of the present invention.

Referring to FIG. 11, a component may include a data component (dbtable1, data_store). A data component can be connected to a DB on the Web through SQL or RESTful/SOAP, and can indicate an object by receiving data from the connected DB. The application development environment providing apparatus 100 may provide a binding for connection with a DB to a data component. As such, a developer can perform data binding between application and DB without knowledge of the SQL or RESTful/SOAP.

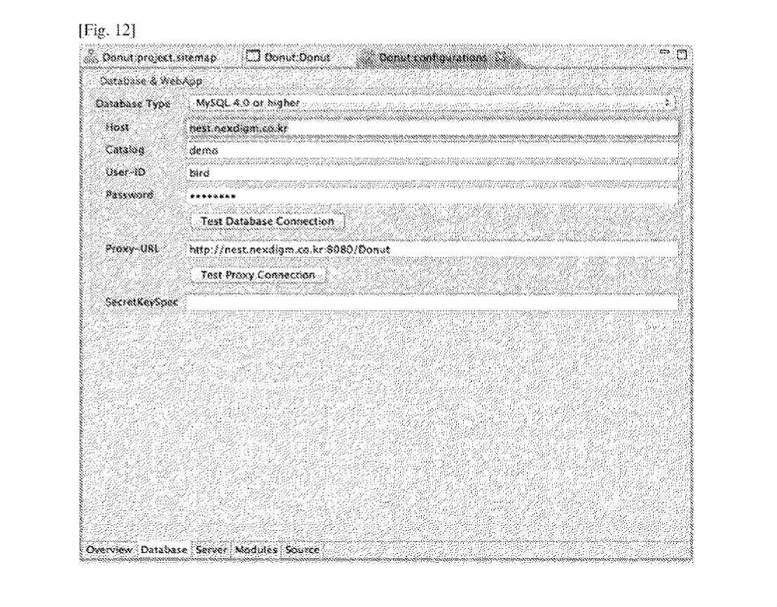

FIG. 12 shows a relational database management system (RDBMS) of an application development environment providing apparatus 100 according to an embodiment of the present invention.

As shown in FIG. 12, an application can be connected to an RDBMS. Therefore, the application development environment providing apparatus 100 can display a setup window for an RDBMS. To this end, an application development environment providing apparatus 100 can comprise an interface for setting up DB type information for setting up RDBMS corresponding with an application, host information, catalogue information, used ID information, password information, test button, proxy URL information, proxy connection test button and SecretKeySpec information.

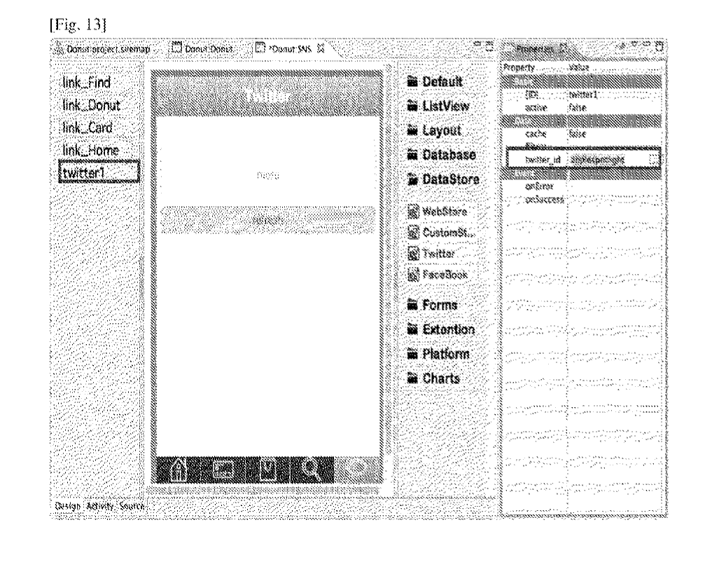

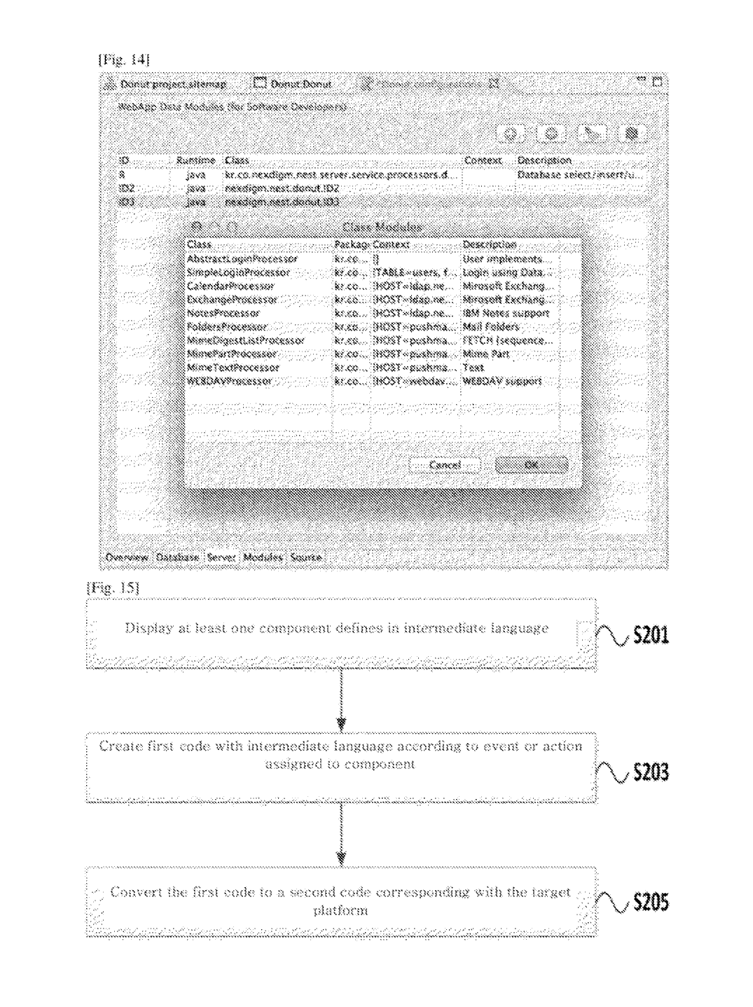

FIG. 13 shows a method for setting up open API type data by the application development environment providing apparatus 100 in accordance with the present invention.

As shown in FIG. 13, a component can be connected to open API type data. For example, Twitter1 components shown in FIG. 13 can be connected to an open API of a tweeter which is a type of SNS. For this setting, the application development environment providing apparatus 100 may further display an interface for setting up Twitter ID.

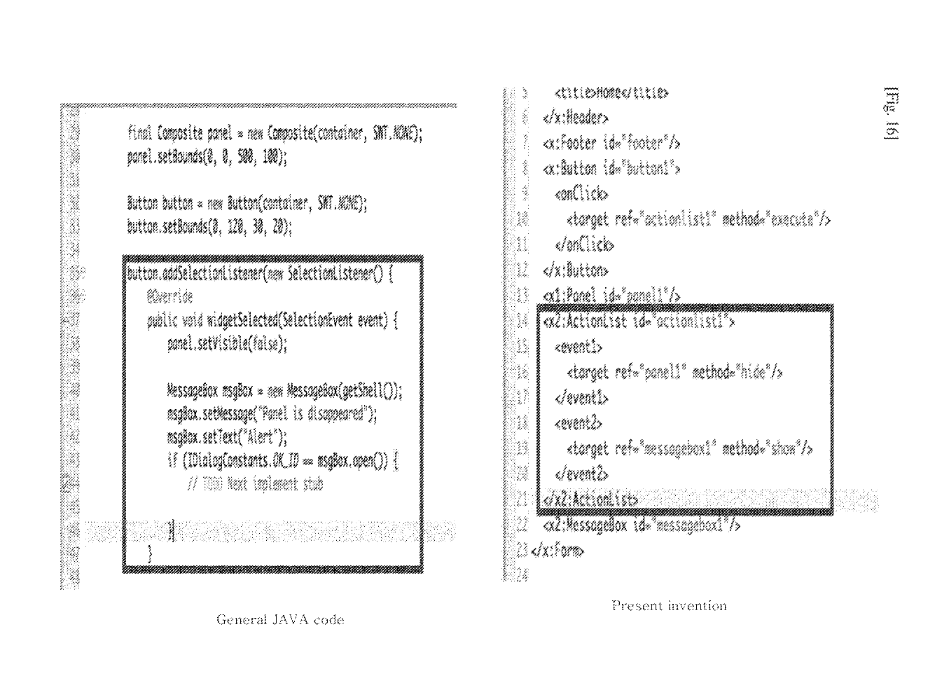

FIG. 14 shows a specialized Restful/SOAP setting method of an application development environment providing apparatus 100 according to an embodiment of the present invention.

As shown in FIG. 14, an application development environment providing apparatus 100 can provide a Restful/SOAP setting window for professional Restful/SOAP setting. Using the application development environment providing apparatus 100, a developer having expertise can perform detailed inter-class modular setting and server connection setting.

A method for providing an application development environment is described in further detail by referring to FIGS. 15 through 24.

FIG. 15 shows a method for providing an application development environment according to another embodiment of the present invention.

Referring to FIG. 15, an application development environment providing apparatus 100 in accordance with another embodiment of the present invention displays at least one component defined with intermediate language in a window (S201) and generates a first code (S203) composed of the intermediate language according to the event or action specified in the component.

An application development environment providing apparatus 100 in accordance with an embodiment of the present invention can display at least one component defined with intermediate language on a window. The intermediate language may include an XML-type language for applying an application to a target terminal. In addition, the intermediate language can be generated on the basis of the connection-relationship window between components as described above. As a result, an application development environment providing apparatus 100 in accordance with an embodiment of the present invention can avoid overlapping development of a same application for adapting to different platforms by using an intermediate language.

FIG. 16 shows a comparison of the intermediate language in accordance with an embodiment of the present invention and conventional JAVA code.

As shown in FIG. 16, numerous and complex codes can be created in short and simple codes with the intermediate language, different from the JAVA code. In addition, the intermediate language can be created automatically with the application development environment based on the connection relationship between components provide by the application development environment providing apparatus 100, reducing labor of developers. In addition, changing and maintenance of scenario can be implemented more easily.

FIG. 17 shows an XML format of the component defined by the intermediate language.

As shown in FIG. 17, the components can be implemented with XML codes defined with the intermediate language. In particular, the intermediate language must be a platform-neutral and the final stage requires generating codes optimized for the pertinent each platform.

Therefore, the intermediate language as shown in FIG. 17, according to an embodiment of the present invention can be defined with XML elements, and an application development environment providing apparatus 100 can create codes optimized for pertinent platform at the final building stage, using the XML elements.

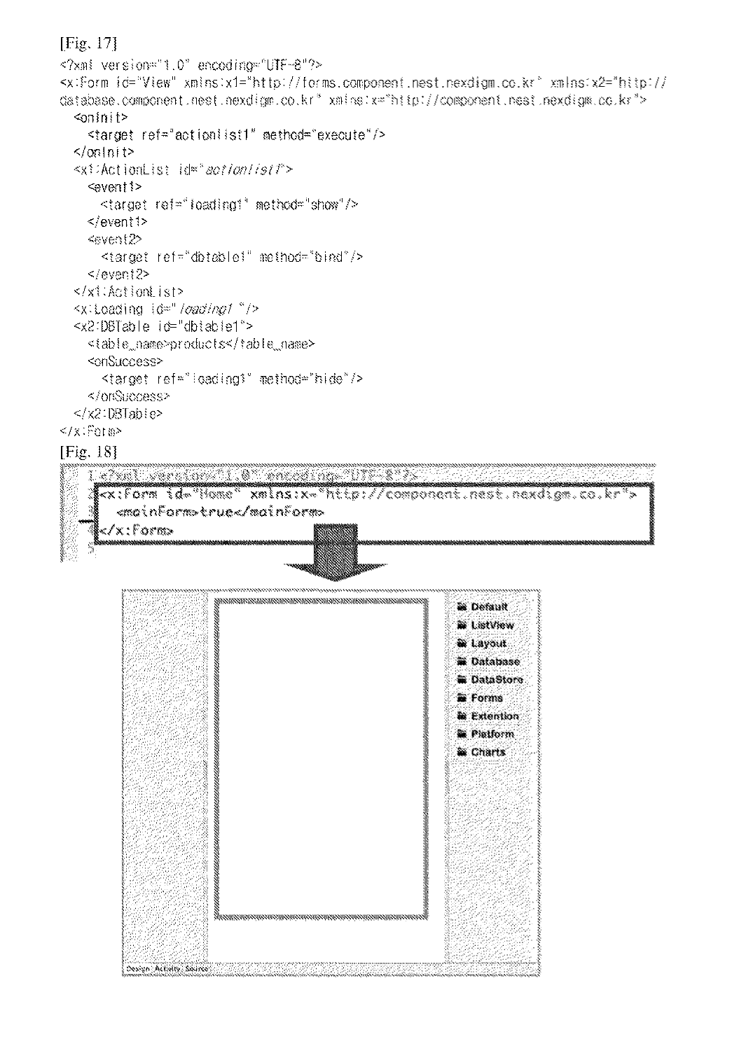

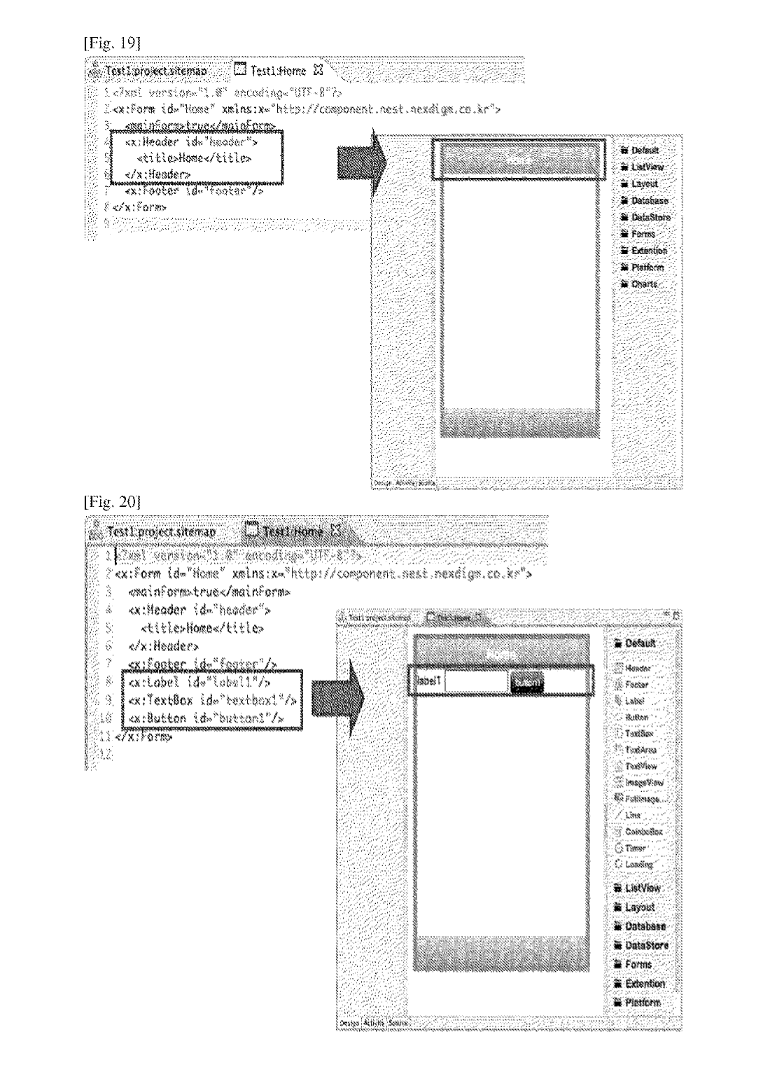

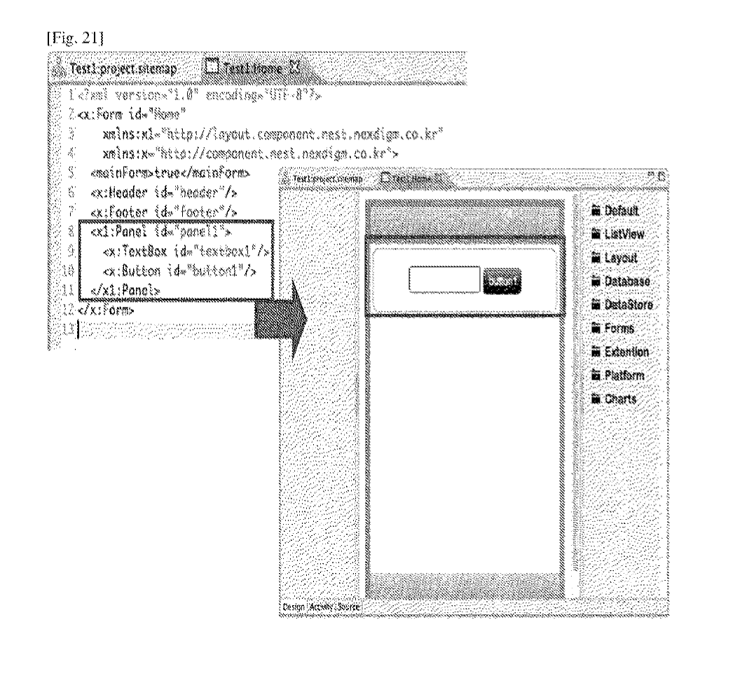

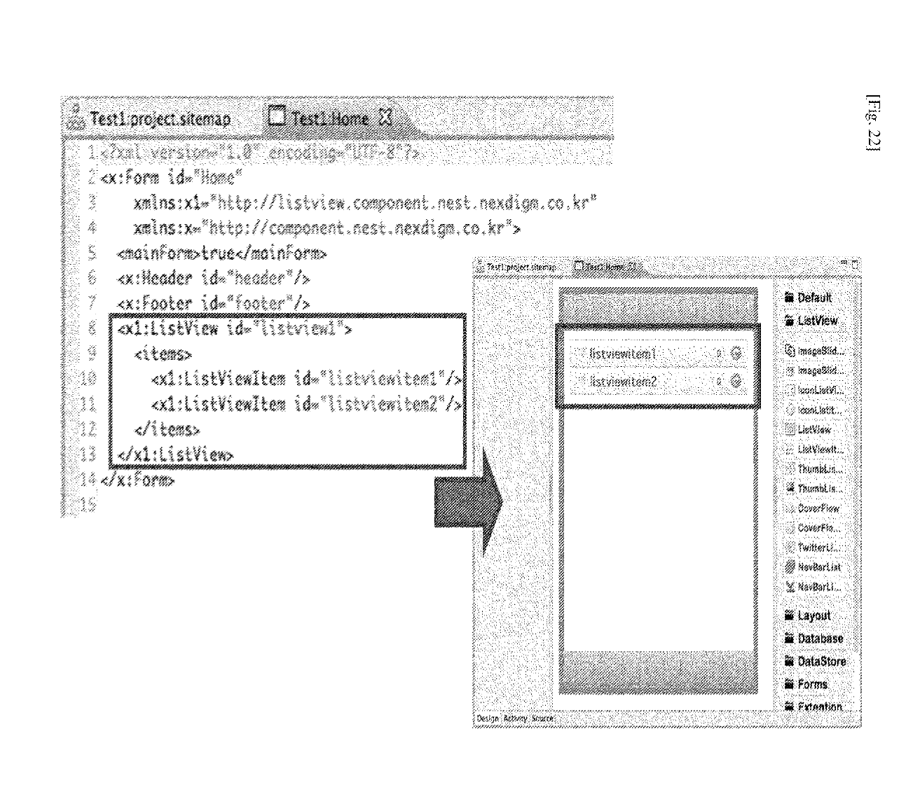

FIGS. 18 to 23 provide explanation of the specific type of XML code components in an embodiment of the present invention and structure of a first window or a second window, according to the type.

FIG. 18 shows an XML code for the basic form of the components provided by the application development environment providing apparatus 100 according to an embodiment of the present invention. As shown in FIG. 18, the basic form component can exhibit a blank margin.

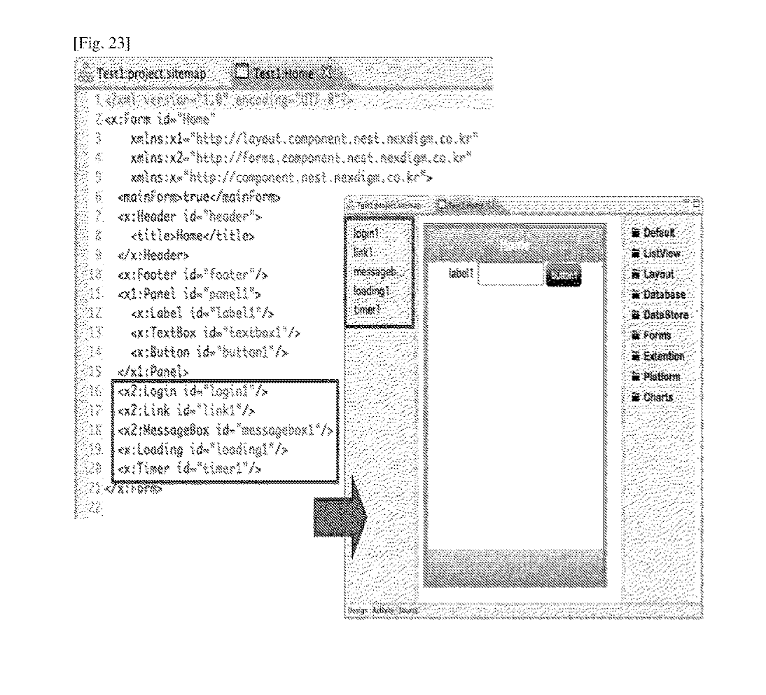

FIG. 19 shows a header component and a footer component (footer) provided in an application development environment providing apparatus 100 according to an embodiment of the present invention. As shown in FIG. 19, the header and footer components may correspond to the top bar which is displayed at the top or bottom bar at to bottom of the page.

FIG. 20 shows a label, text box, and a button component provided by the application development environment providing apparatus 100 according to an embodiment of the present invention. As shown in FIG. 20, each label, text box, and a button component may correspond to specific position of application page and XML code.

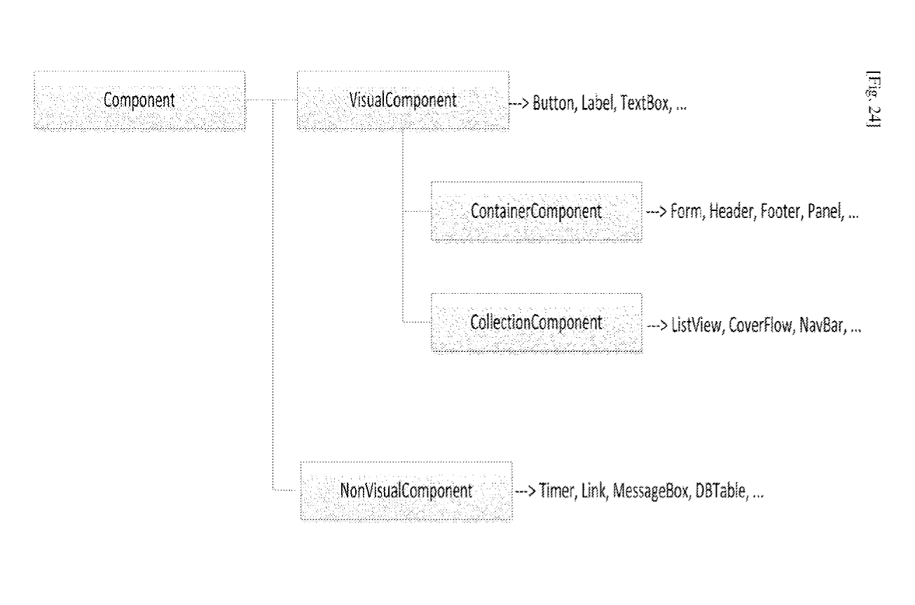

FIG. 21 shows container-type components provided by the application development environment providing apparatus 100 according to an embodiment of the present invention. Referring to FIG. 21, if a component contains other component(s), the component can be a container-type component. For example, since the Panel1 component can include a textbox1 component and a button1 component, the Panel1 component can be a container-type component.

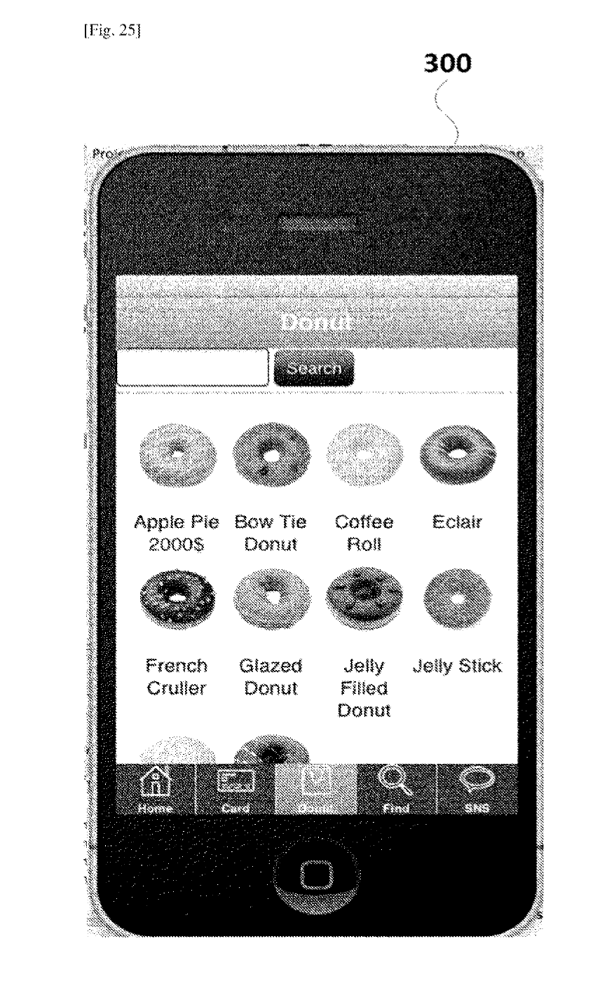

On the other hand, FIG. 22 shows list-type components provided by the application development environment providing apparatus 100 according to an embodiment of the present invention. Referring to FIG. 22, for example, a list-type component may list a plurality of component items. And, as shown in FIG. 22, the application development environment providing apparatus 100 may generate an XML code corresponding to a list-type component for listing.

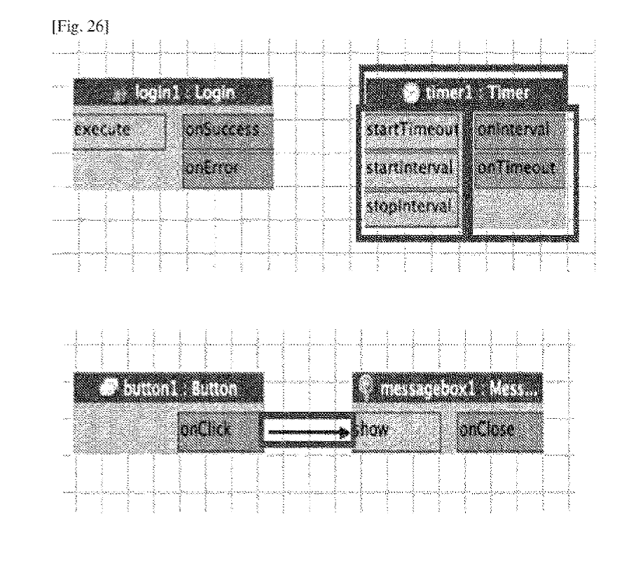

And, FIG. 23 shows non-visual components provided by the application development environment providing apparatus 100 according to an embodiment of the present invention. Referring to FIG. 23, for example, a component which exists but not displayed in a page, the component may be a non-visual component.

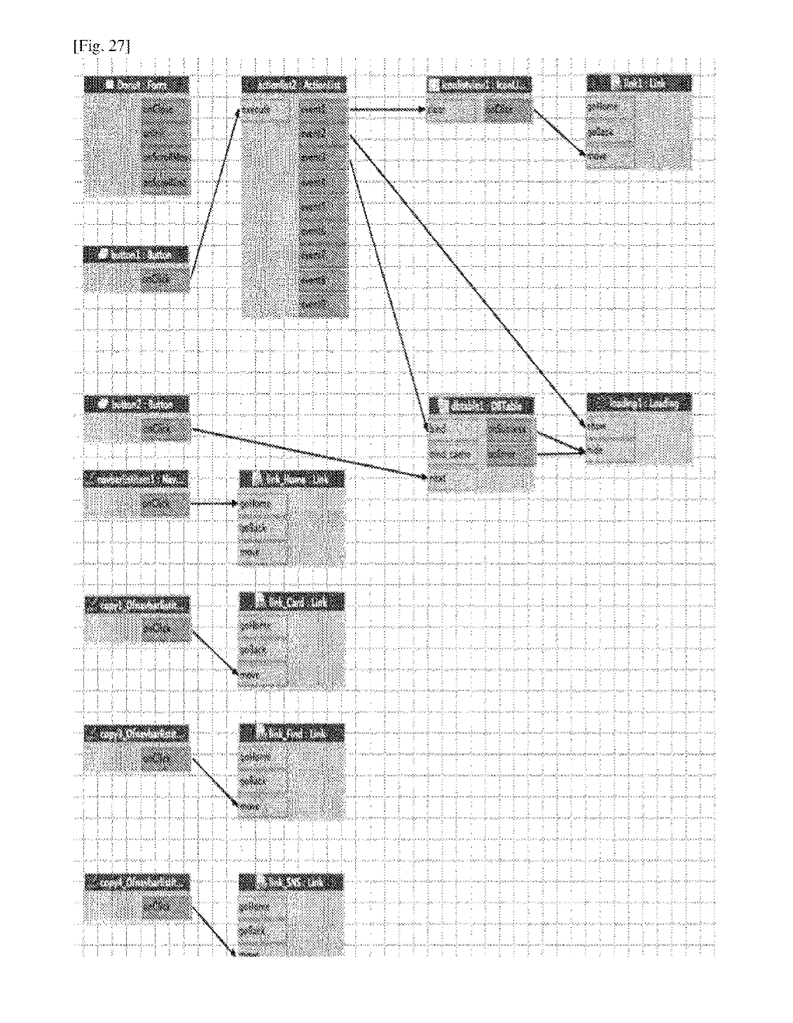

A component may have a structure as shown in FIG. 24.

Referring to FIG. 24, for example, a component may include a visual component, a container component, a collection component and a non-visual component.

A visual component may be a common user interface component (button, label, text box, etc.), a container component may be a user interface component which includes visual components (forms, header, footer, panel). And, a collection component may be a user interface component (list view, cover flow, navigation bar) that represents a list and a non-visual component may be the components not shown in a window but takes care of specific action or data processing (timer, link, message box, db tables).

Each component can be composed of an intermediate language in a corresponding XML format it. A first code composed of an intermediate language is converted to a second code corresponding with a target platform according to the event or action specified in the component (S205).

A component composed of an intermediate language may have the form of XML. For example, each component may represent a node unit of XML. And, each component can be declared over the qname and id attribute. The prefix of the qname can mean a namespace, and name may have a component name. And, id attribute may have a unique value in a page, beginning with an Alphabet and comprising a combination of alphabetic characters and numbers.

On the other hand, the top-node in an intermediate language can represent a page. Accordingly, prefix of qname can be declared by xmlns:attribute of the page element.

And, the pages constituting one window may be present as a single file unit, and an id element of a page can have a unique value in all pages.

The actions and events of these components may be included as a child element of declared component elements. For example, a container component may include visual components as the child elements. In addition, a collection component may include a collection of item components in the form of item element. In addition, all components may include at least one of event and action.

FIG. 25 shows a window of a target terminal 300 which is executing an application which is converted by an application development environment providing apparatus 100 into a second language executable in the target terminal 300.

An application development environment providing apparatus 100 in accordance with an embodiment of the present invention can convert the codes created with an intermediate language into a second language suitable for a target device. For example, an application development environment providing apparatus 100 according to an embodiment of the present invention can convert an intermediate language into a second language, such as iOS series, Android series, and Tizen OS directly, maximizing development efficiency.

In addition, an application development environment providing apparatus 100 according to an embodiment of the present invention can provide a simulation window of a target platform with an application development environment. Accordingly, the developer is able to determine in advance whether or not the application can run on the selected device.

FIG. 26 and FIG. 27 show the arrangement of the components in a second window provided by the application development environment providing apparatus 100 according to another embodiment of the present invention.

An application development environment providing apparatus 100 in accordance with an embodiment of the present invention may deploy instance name of component object, object name and icons in the top area of the component object in order for efficient display of the components and the connection relationship between the events and actions. This enables easy discernment of the components, as shown in FIG. 26.

Here, in one side of the component object, box-type actions can be placed while box-type events can be placed in the opposite side. The connection relationship from the events to the actions can be indicated with the direction of arrow images. As a result, a developer can grasp smooth flow of application connect one side to the opposite side.

On the other hand, in order to express components and the connection relationship between the events and actions efficiently, an application development environment providing apparatus 100 in accordance with an embodiment of the present invention needs to display the components in a well-arranged manner.

As shown in FIG. 27, for arranging the components, the application development environment providing apparatus 100 places the top form page at the highest position to the left, the buttons and menu items at the second highest position, the links (arrow images) corresponding with the buttons and menu items at the third highest position, and the items not frequently used, for the events such as headers and footers, at the lowest position.

In this way, as shown in FIG. 27 the components can be arranged corresponding with the flow from the left to the right, and the developer need not take the efforts to rearranging the components.

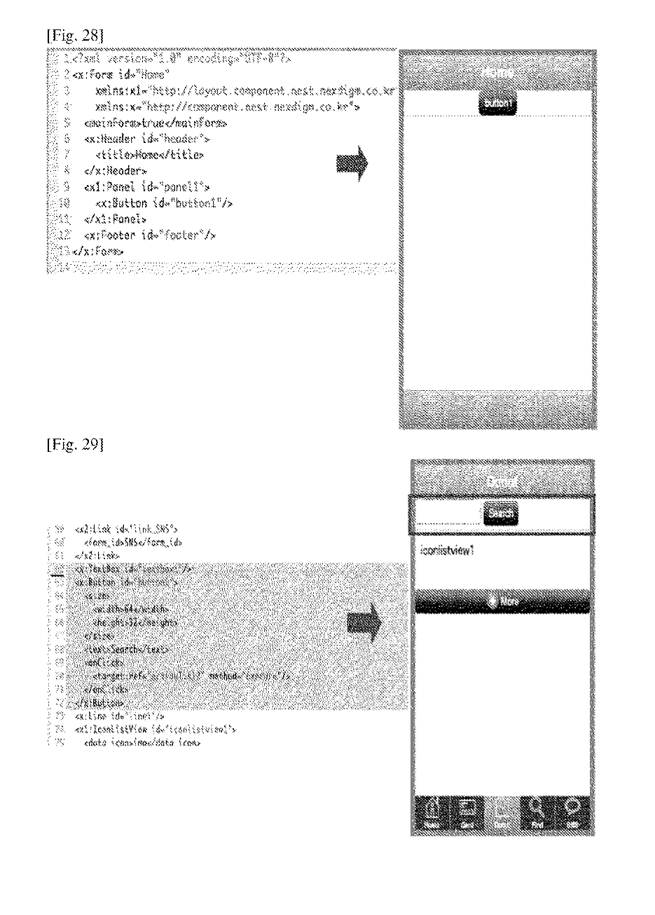

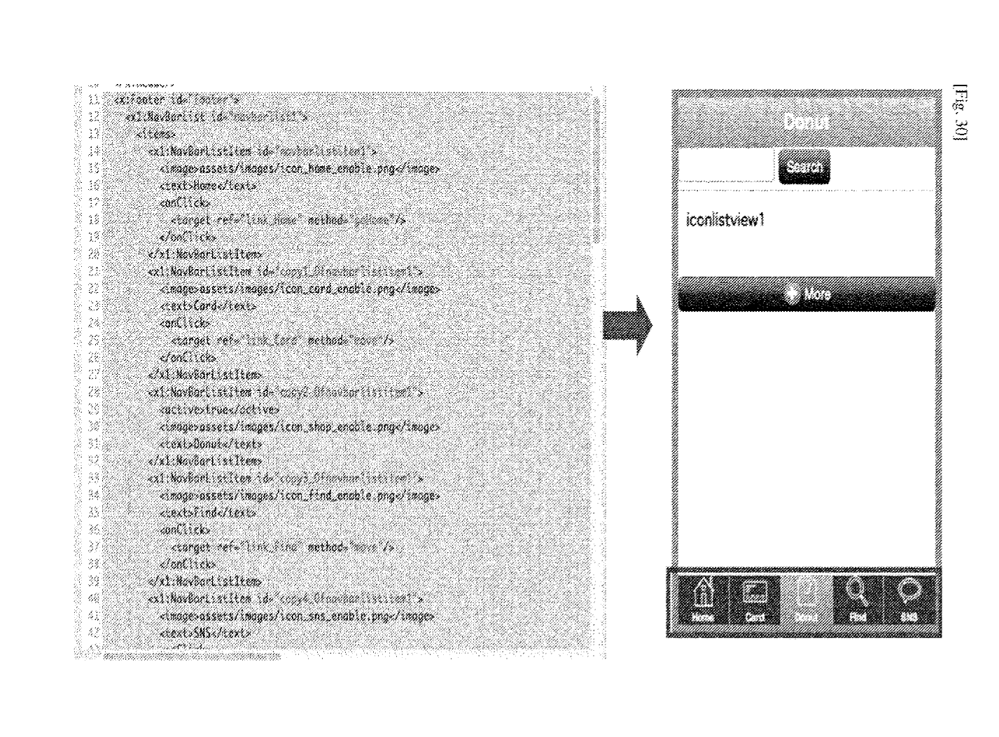

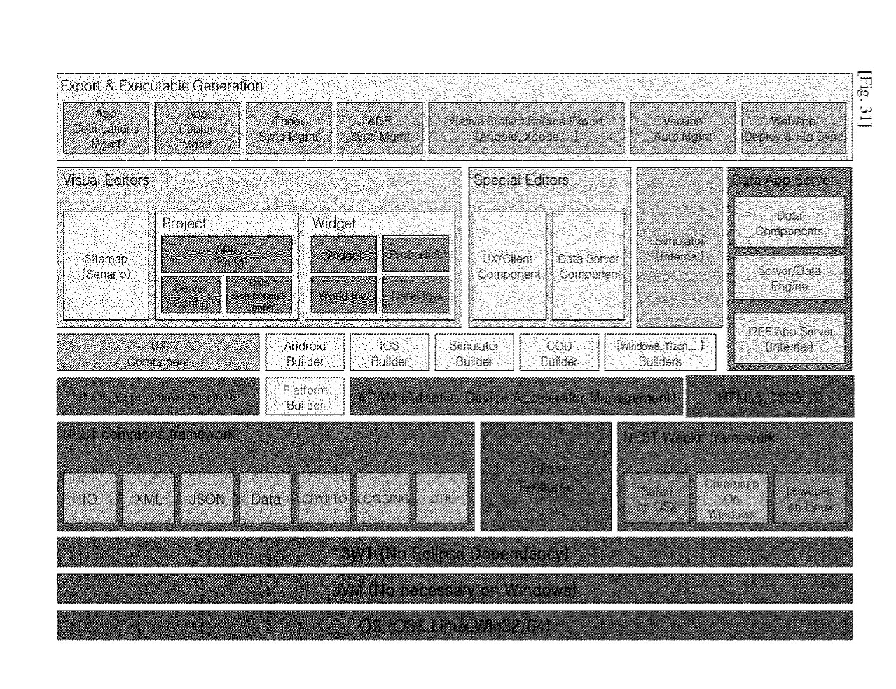

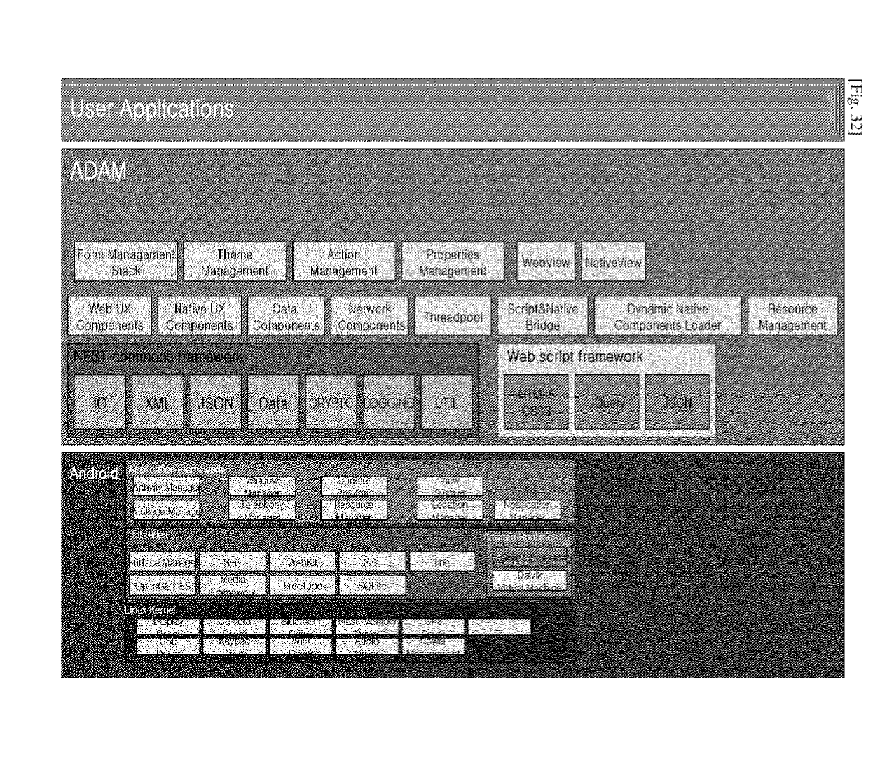

FIG. 28 shows a layout method of the application development environment providing apparatus 100 according to another embodiment of the present invention.

Conventional hybrid application development tools can not support a wide range of resolution. In particular, conventional application development tools supporting WYSWYG designs UI components in the X and Y coordinates only in order to apply layout coordinates by drag and drop operation. However, this method requires to develop a new screen if the resolution of the terminal is changed, or the display mode is switched between portrait and landscape.

Thus, referring to FIG. 28, the application development environment providing apparatus 100 in accordance with an embodiment of the present invention can make use of a block layout system which enables same expression regardless of terminal types and resolutions, using block units.

When arranging a window using UI components, the block layout system does not make of the X and Y coordinate information, but may mean a system arranging at the top, bottom, left and right with reference to the container component. In this case, even if the resolution is changed, all the components remain at the same positions so that all the target terminals can display the same layout.

In addition, if consecutive components are arranged, for example, button 1, button 2, and button 3 are to be arranged, even if only the sizes of each button are defined, the same layout can be expressed even if the window rotates or displayed on a device having a different resolution.

FIGS. 28 to 30 show the embodiments of such block layout.

For example, as shown in FIG. 28, of the components, header, panel1 and footer can be arranged at the top, middle and bottom, respectively. Form, header, footer and panels may serve as a container component, wherein each container will be able to provide a vertical arrangement.

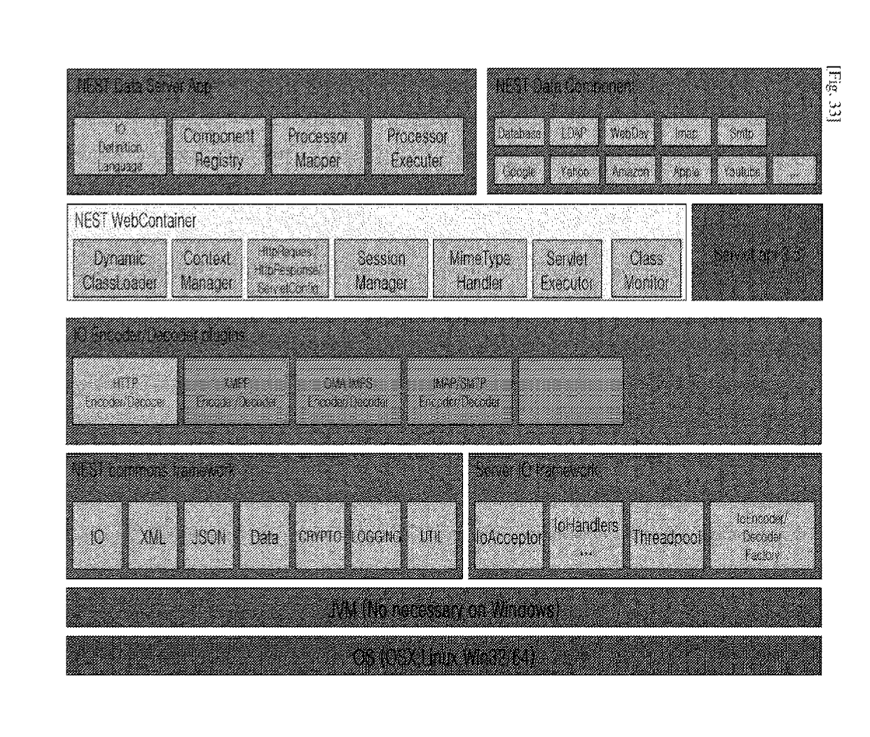

FIG. 29 is a view for explaining a method of using the application development environment providing apparatus 100 according to the embodiment of the present invention for producing an application without the X, Y coordinate information for text box component and button component.

Referring to FIG. 29, an application development environment providing apparatus 100 according to an embodiment of the present invention can set the width and height of the text box component and button component without X, Y coordinate information. In this case, in an actual window display, the text box is deployed followed by button on the right, so that the applications created in the application development environment can be converted to a resolution suitable for the target terminal without X and Y coordinates conversion.

FIG. 30 shows a method for arranging the components with an application development environment providing apparatus 100 in accordance with an embodiment of the present invention.

As shown in FIG. 30, an application development environment providing apparatus 100 in accordance with an embodiment of the present invention can deploy a navigation component in the footer area in the bottom of the page. In this case, for the navigation component of the container type, the application development environment providing apparatus 100 may change the size of the Child components according to the resolution of the target terminal 300. And, the resized Child components may fill up the window.

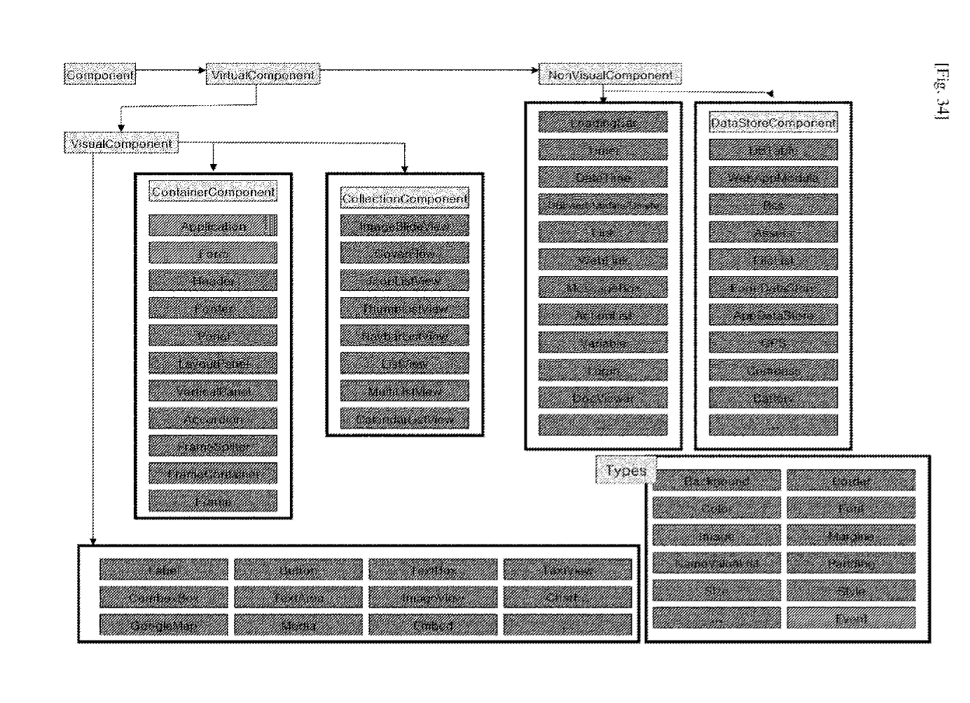

FIG. 31 is a block schematic diagram showing the platform of the application development environment providing apparatus 100, FIG. 32 is a schematic block diagram showing the platform of a terminal 300 which can execute the application, and FIG. 33 is a block diagram showing the architecture of a server 300.

An application development environment providing apparatus 100 in accordance with an embodiment of the present invention can support a variety of deployment types according to the preference of the developer and/or purpose, and can be implemented with various system frame works for this purpose. According to an embodiment of the present invention, in the case of iOS, 3 types including xarchive, ipa, and Xcode project can be supported and automatic authentication signing can be supported. For Android devices, 2 type including apk and ADT project can be supported and automatic creation and signing of authentication can be supported, in addition to WAR packaging via Data Server and server uploading via ftp.

An application development environment providing apparatus 100 according to an embodiment of the present invention can be designed to embed Webik engine and run in OSX, Linux, and Windows in order to implement Once Source and Multi Platform. An application development environment providing apparatus 100 can provide an application development environment, differentiated from eclipse, so that the developers do not need additional setting and developer's installation requirements such as WAS. In addition, JVM and Webkit are embedded and no extra installation or setup is necessary.

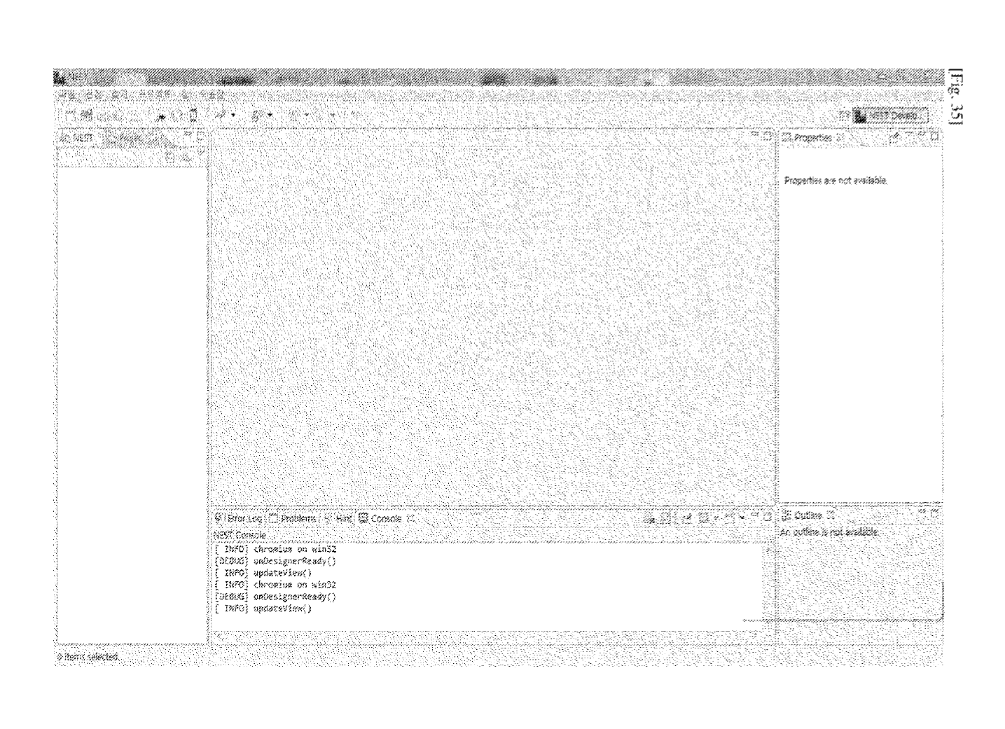

FIG. 34 shows a component configuration structure according to an embodiment of the present invention.

Referring to FIG. 34, a component may comprise a virtual component, and may comprise visual and non-visual components in the lower level. And, the visual component can comprise at least one of a label, button, text box, the text view, combo boxes, text areas, image view, chart, Google Maps, media or an embedded component, and further may comprise container components and collection components in the lower stage.

A container component may comprise at least one of application, form, header, footer, panel, layout panel, vertical panel, Accordion, Frame splitter, frame container and frame, and the collection container can comprise at least one of image slide view, cover flow, icon list view, thumbnail list view, navigation bar list view. multi-list view and calendar list view components.

In addition, a non-visual bar can comprise at least one of loading bar, timer, date and time, DBinsert/Update/Delete, link, web link, message box, action list, variable, login and view components, and may further comprise datastore components in the lower level. The datastore component, with respect to DB, may comprise at least one of DB table, Web app module, Rss, Assets, file list, form data store, app data store, GPS, compass and battery components.

Hereinafter, referring to FIGS. 35 to 52, the process of creating an application is described referring to the windows provided by the method of developing apps in accordance with an embodiment of the present invention.

FIG. 35 shows a window for creating a project for providing an application development environment according to an embodiment of the present invention. In FIG. 35, by clicking Create in the file menu, a developer can make choices for the project.

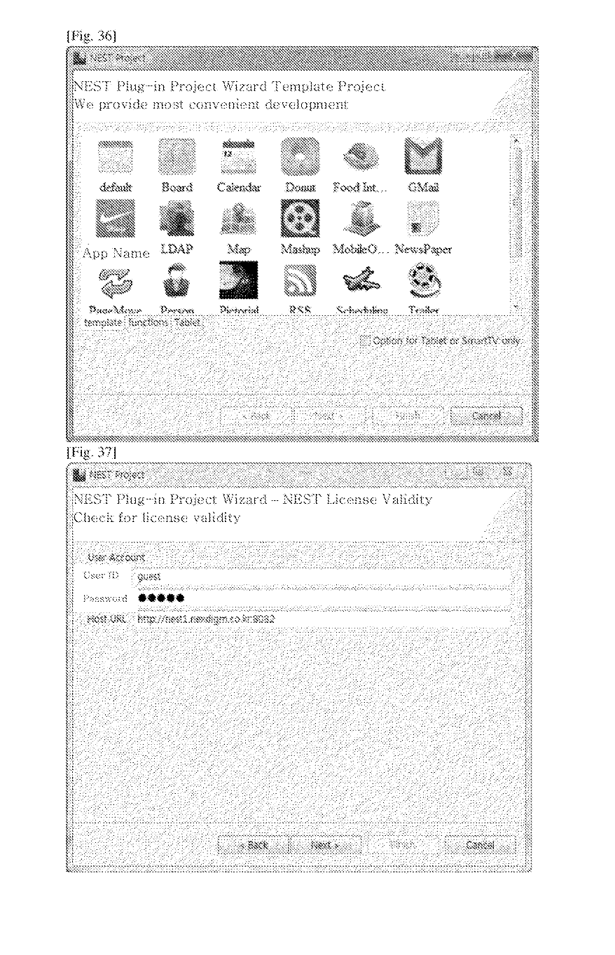

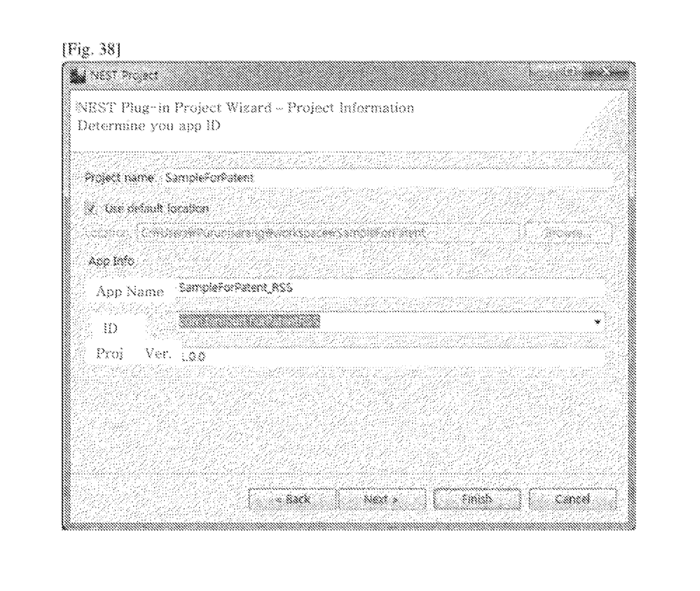

Hereinafter, as shown in FIG. 36, when a developer selects a new project, a window providing a plurality of templates can be displayed. In particular, in addition to the templates, function and the tablet can be provided, and if the developer selects Default, an interface that enables the developer starting a desired project without a template can be provided. If the developer selects a specific template from a plurality of templates, a new project can be created on the basis of a template where basic configuration has been set up already.

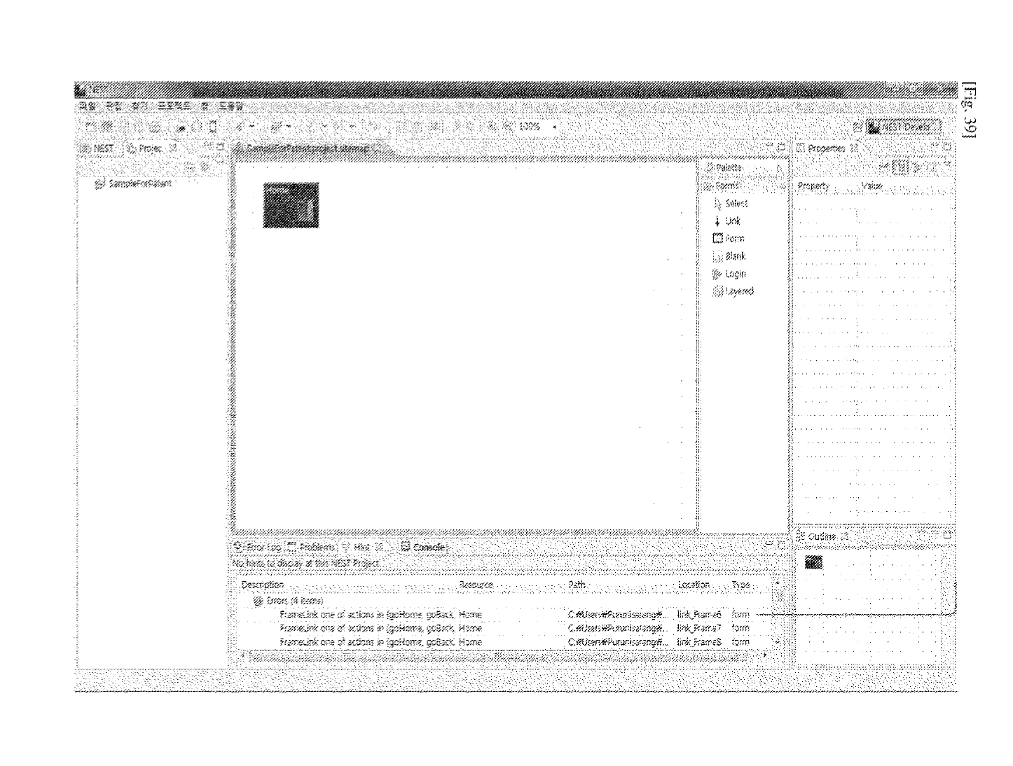

FIG. 37 shows a window for license validation for creating a project. A Server 200 or an application development environment providing apparatus 100 can verify license for creating a project on the basis of the user, password and host URL. In addition, the application development environment providing apparatus 100 may be restricted to be allowed to proceed to the next step only when a purchase is authenticated or verified to be used as an ASP service.

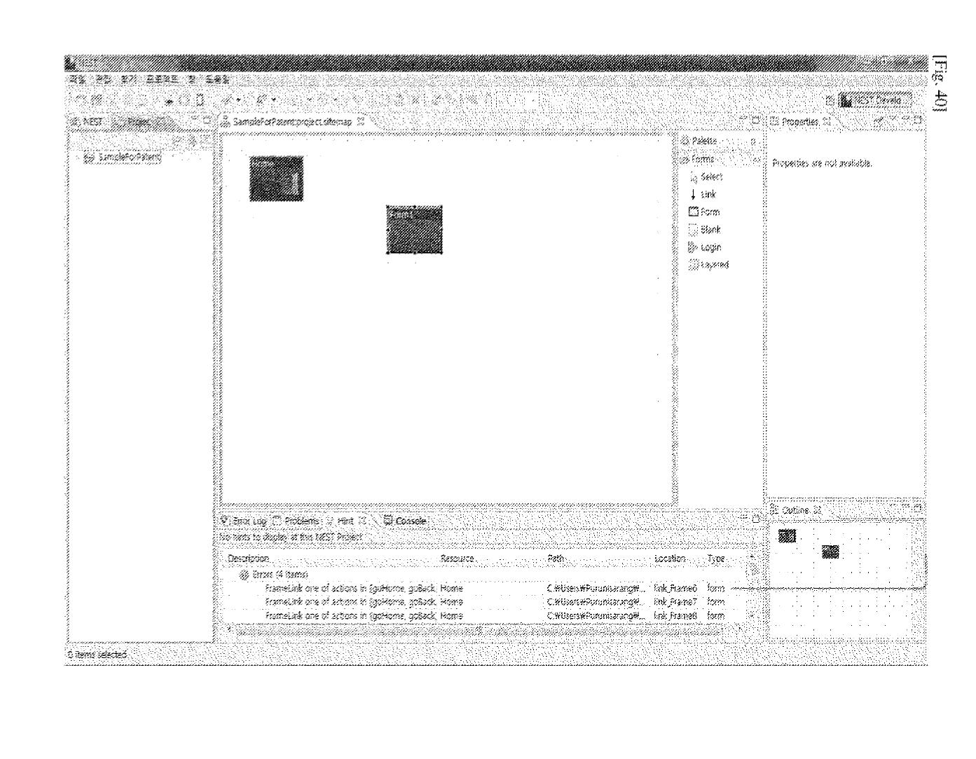

FIG. 38 shows a project information setting window. Project Information setup window can setup the name, application name, ID, and project version of the project for application development.

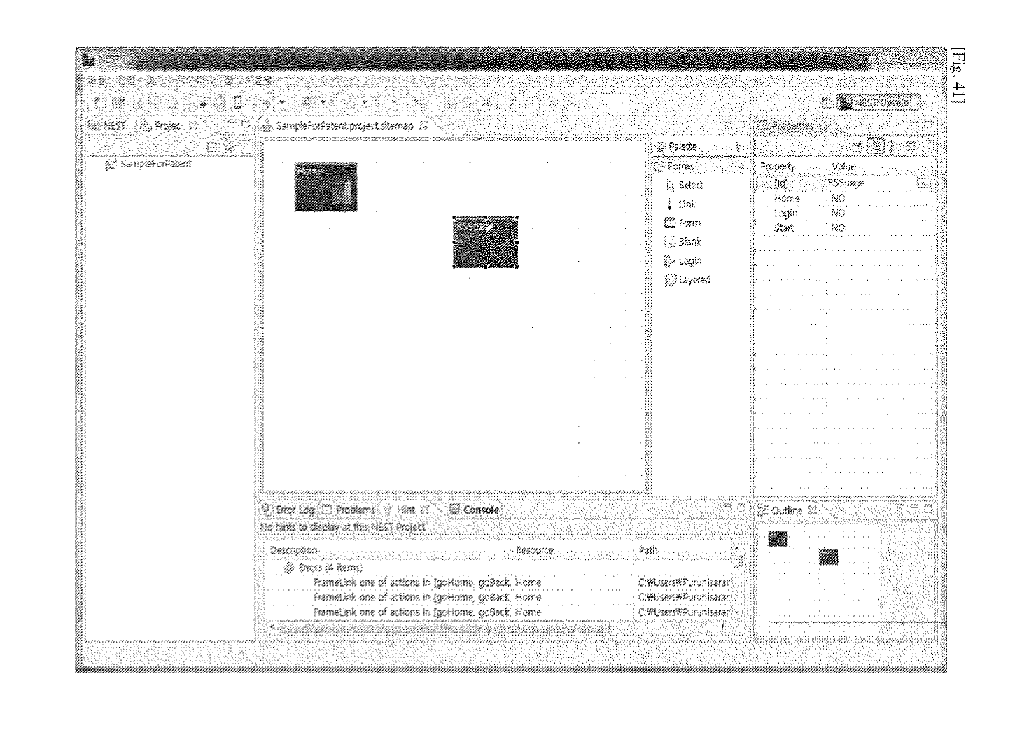

FIG. 39 shows an application development environment including a first window according to an embodiment of the present invention. In particular, the first display may correspond to a sitemap editor window of FIG. 39. FIG. 39 includes a default Home page pre-generated by a previously selected RSS template and activated.

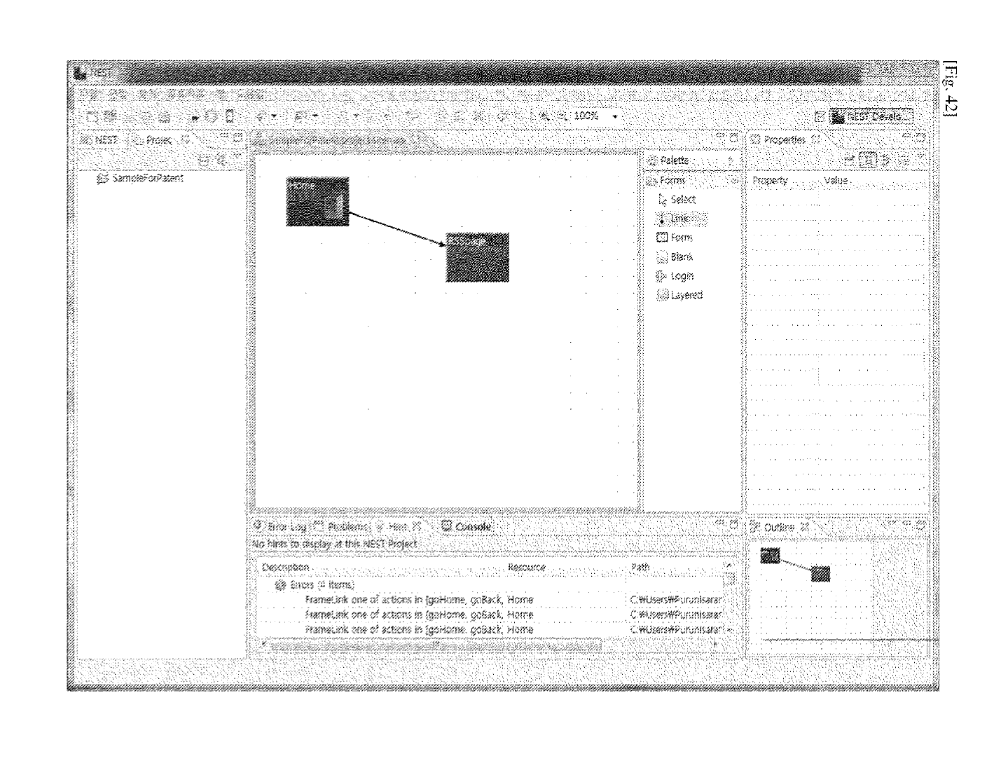

FIG. 40 shows that a new page is added to the first window. As described above, an application development environment providing apparatus 100 in accordance with an embodiment of the present invention allows adding a page using drag-and-drop. For example, a Form page can be added by drag-and-drop a Form page in the right-side palette of the sitemap editor, as shown in FIG. 40, in the first window.

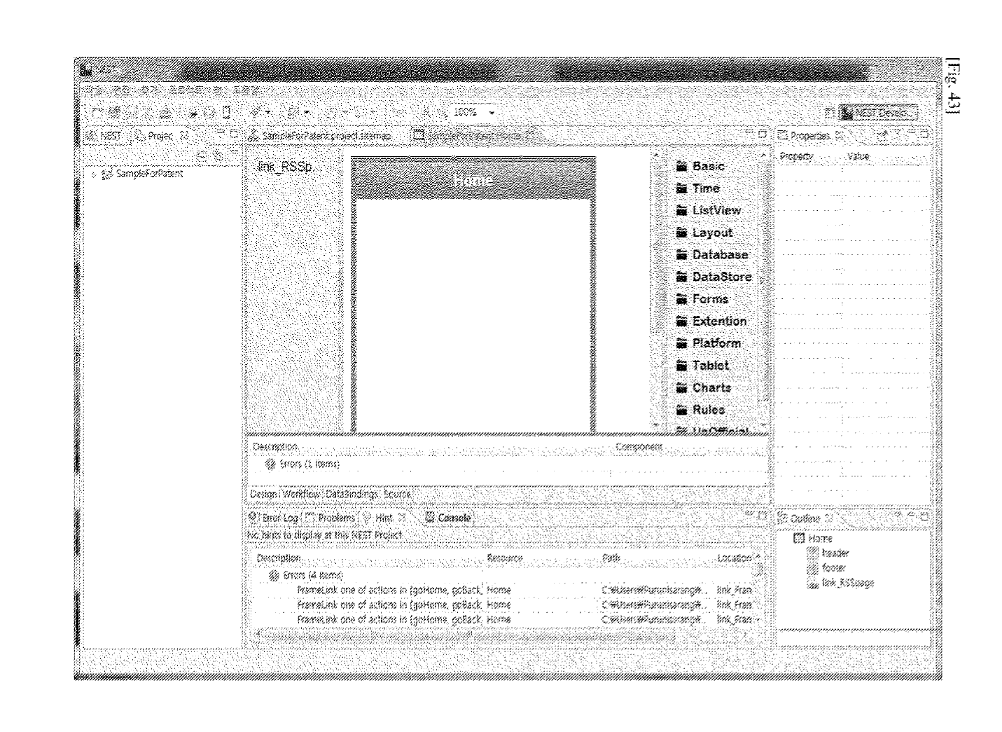

FIG. 41 shows changing page ID by changing the attribute of the Form page to RSSpage. A developer can change attribute through the input interface shown in the attribute window.

FIG. 42 shows connecting between the Home page and RSSpage. As shown in FIG. 42, a developer clicks link, clicks Home page icon which is the starting page for connection, and clicks RSSpage page icon which is the target of the connection to complete the connection. When the connection is complete, the first window may display connection between the pages with arrow images described above.

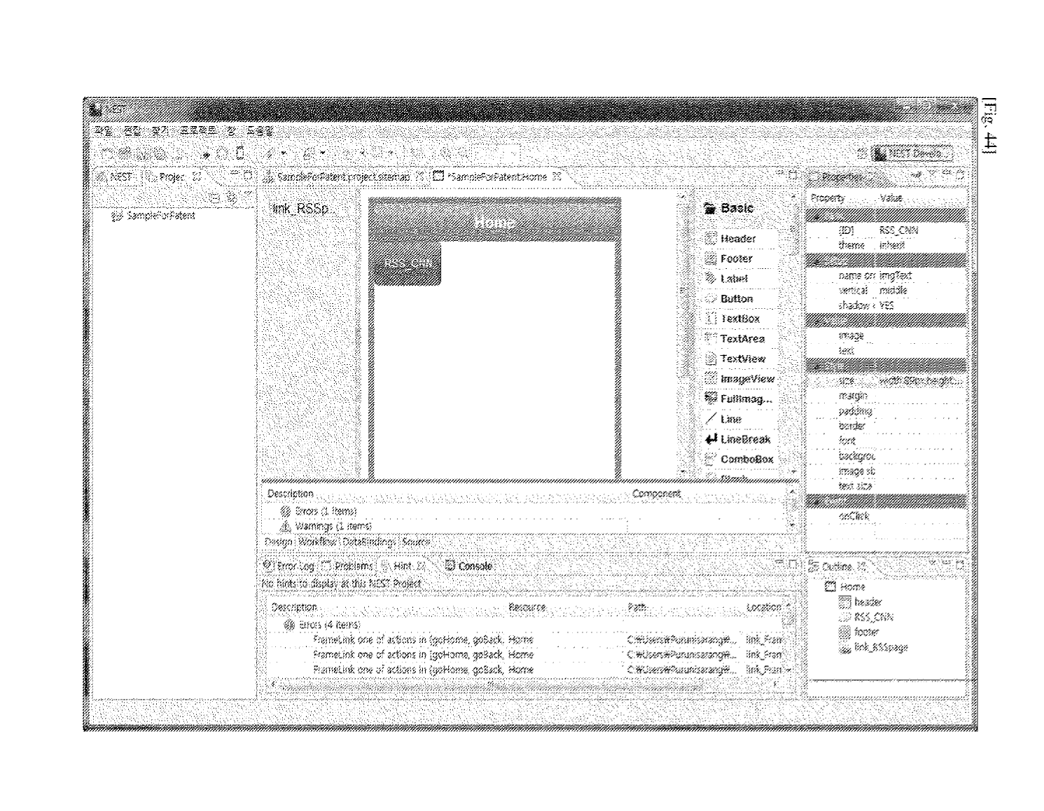

FIG. 43 shows a window for adding components to the Home page. For example, an application development environment providing apparatus 100 can display component adding window by clicking select in the editor of FIG. 42 followed by double-clicking Homepage. As shown in FIG. 43, the type of additional components can be at least one of, but not limited to, Basic, Time, ListView, Layout, Database, DataStore, Forms, Extention, Platform, Tablet, Charts, Rules and Unofficials.

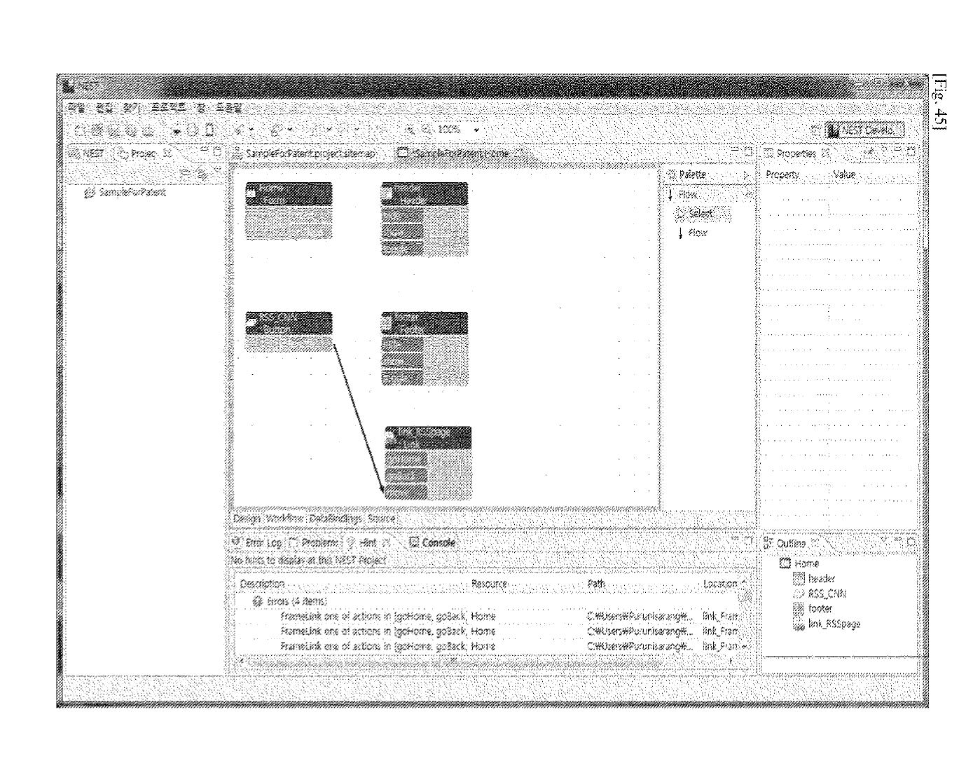

FIG. 44 shows a button component RSS_CNN generated in the Home page. For example, of a Basic type of components, a Button component is drag-and-dropped can added to the Home page, and by changing the ID value to RSS_CNN value in the properties window, an RSS_CNN component shown in FIG. 44 can be created. In addition, the RSS_CNN Button component can be resized by changing the size value in the properties Style tap.

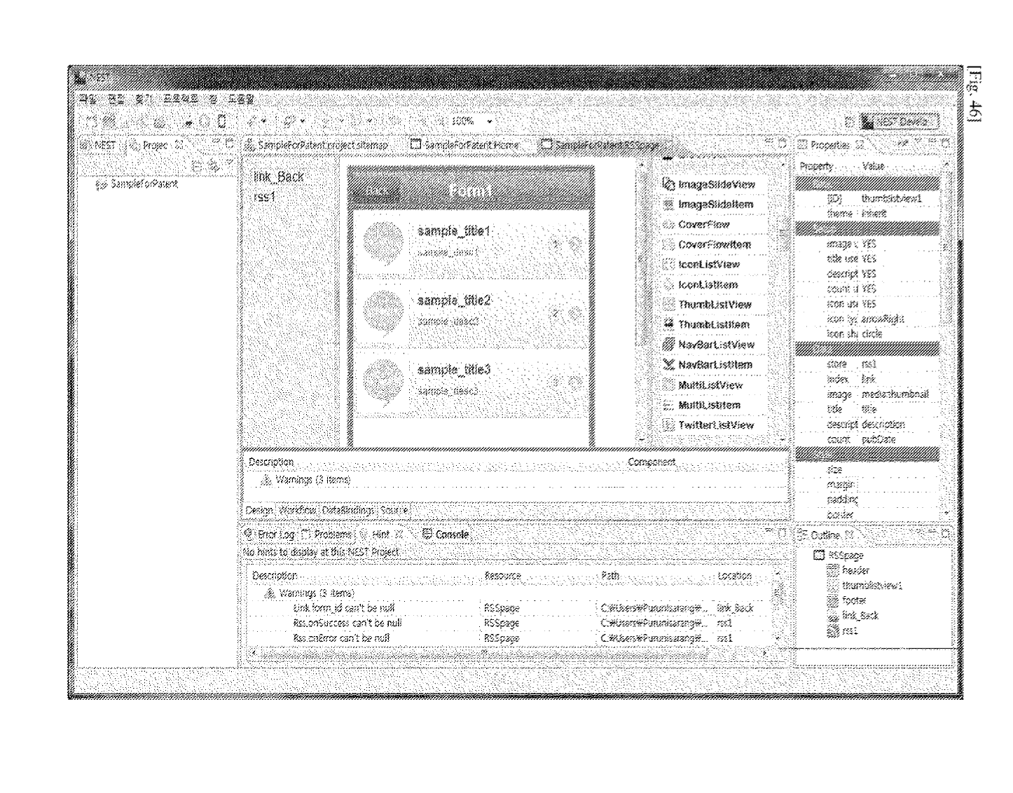

And, FIG. 45 shows a second window showing connection relationship between the components included in the Home page, and indicates that an RSS_CNN button component is connected with a link_RSSpage component. Switching to the second window can be conducted by selecting the Workflow tab on the bottom window. And, a developer can drag-and-drop the icons in the flow window to the right to connect the onClick event of the RSS_CNN button and action of the link_RSSpage. As a result, connection relationship between the components can be indicated with arrow images. Through these link connections, it can be set up that RSS-CNN button is moved to RSSpage by being clicked in the Home page.

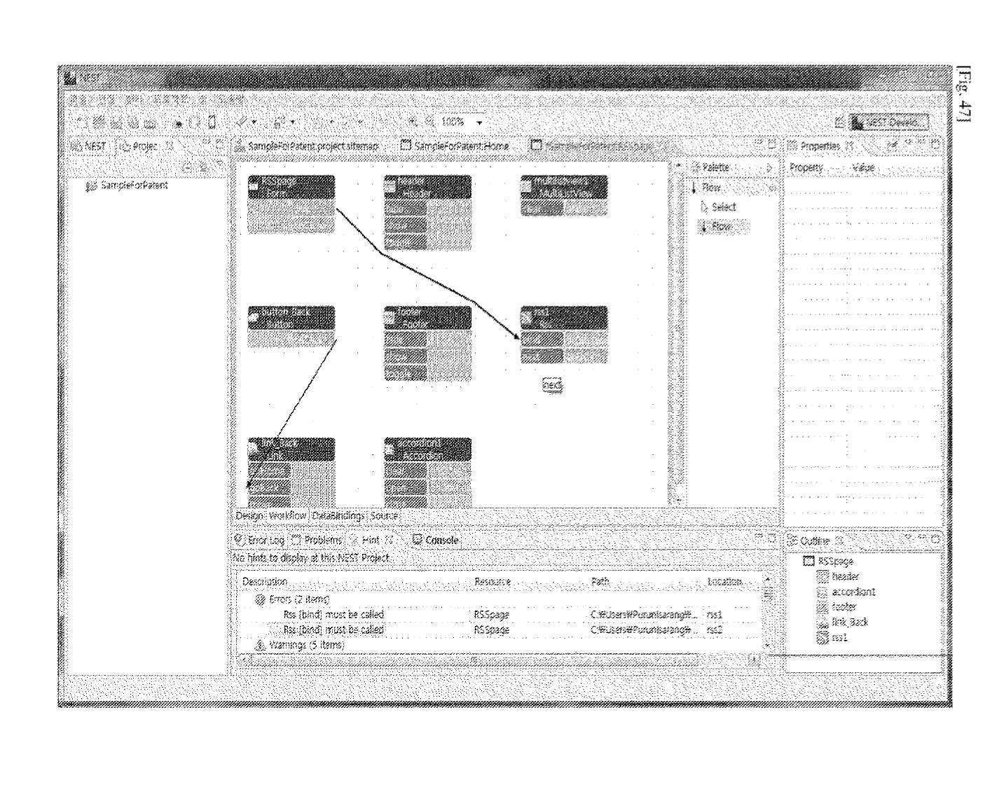

FIG. 46 shows the component adding window of the RSSpage page. As shown in FIG. 46, when ThumbListView is drag-and-dropped to the RSS page, a preset thumbnail list view component can be displayed on the page window of the RSS page.

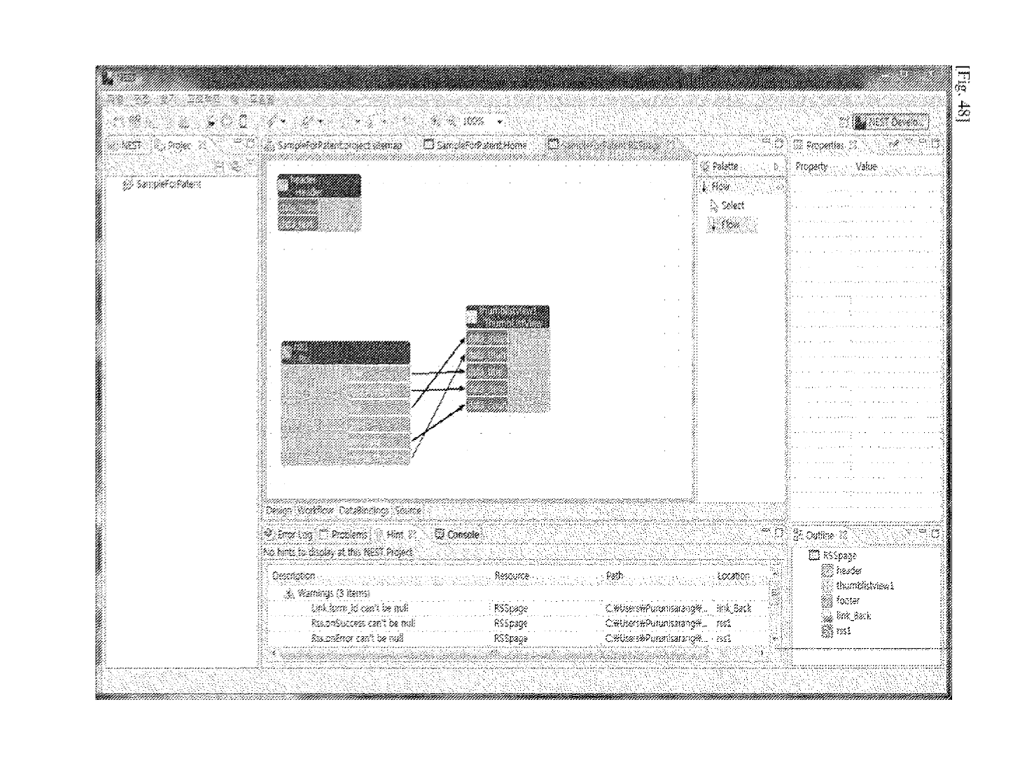

FIG. 47 shows the connection relationship between the components for RSSPage page.

As shown in FIG. 47, an onInit event generated when the RSSpage is initialized can be connected with a Bind action which brings RSS Data. This can be done by clicking flow to connect the onInit event of the RSS page form cont and bind of the rssl component.

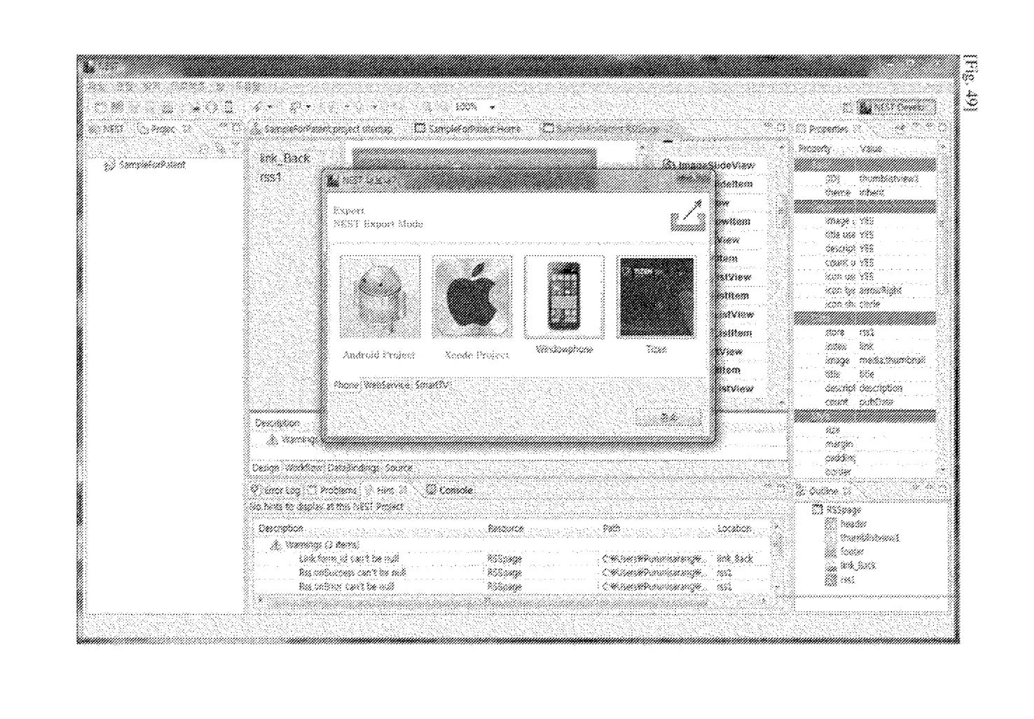

FIG. 48 shows a window for data binding to an RSS component of the RSSpage page.

As shown in FIG. 48, an application development environment providing apparatus 100 can provide a window showing RSS data values in a page. In addition, the application development environment providing apparatus 100 can determine the RSS data shall correspond to what position of the ThumbListView component, and can assign the values formed in the rssl to the corresponding list of the ThumbListView.

FIG. 49 shows an export window for converting a complete application to a target platform. As described above, a complete application can be composed of an intermediate language, and can be converted into a second language according to the target OS. Accordingly, the export window can provide a selection window that allows the user to select a second language. For example, the target of export can be one of Android project, Xcode projects, Windows Phone, and Tizen.

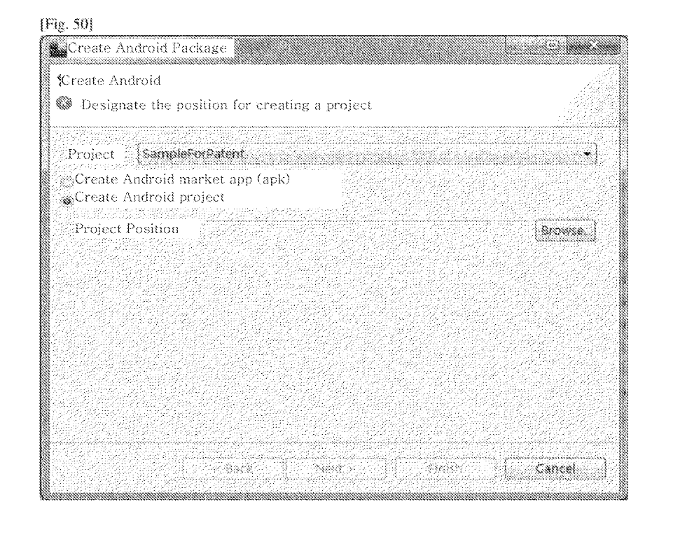

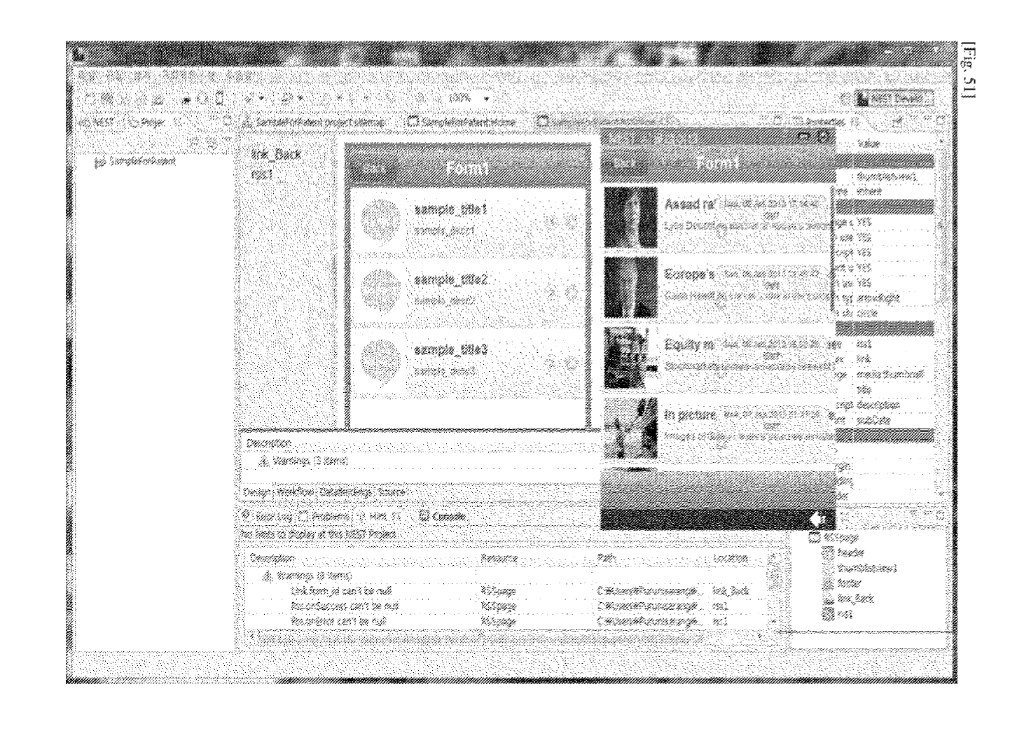

FIG. 50 shows a package generation window, when the Android project is selected. In this case, the application development environment providing apparatus 100 may create an Android market application apk or create a project for developing Android application. When a project is created, the application can be edited with other tools for developing Android applications.

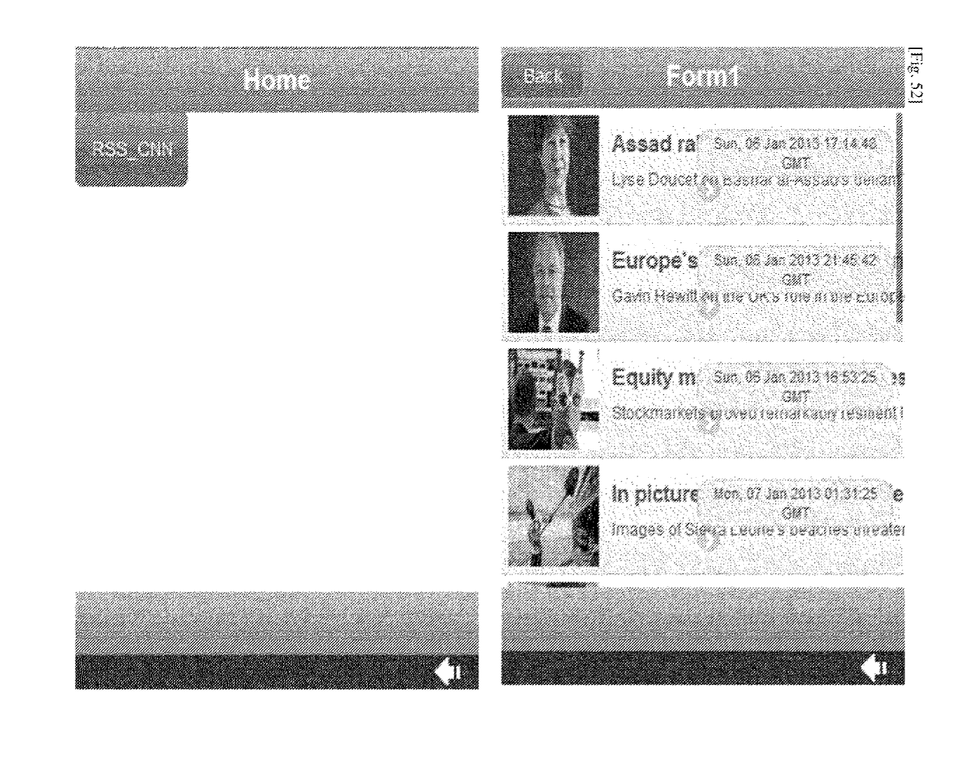

FIG. 51 shows a simulator operating window to test the operation of the application, and FIG. 52 shows a window of a smart device where a final application is converted and outputted, transmitted to and operated in.

As shown in FIG. 52, smart devices, when a user clicks the RSS_CNN button created earlier on the home page, goes to Form1 page (RSSpage), and an application which receives RSS data from Web DB bound with data by the starting up of the Form1 page and display the data in the thumbnail list view component is activated.

In this way, the application development environment providing apparatus 100 of the present invention enables development of applications for various platforms with simple clicks and drag-and-drop operation, without special knowledge in various language codes.

The application development environment providing method according to the present invention described above can be created in a software program executable by a computer system and can be saved in a recording medium readable by a computer system. The computer readable recording medium may include ROM, RAM, CD-ROM, magnetic tape, floppy disc, optical data storage device, or can be implemented in a carrier wave form (for example, transmission via the Internet).

The computer readable recording media can be distributed over network-connected computer systems so that the computer-readable code is stored and executed in a distributed way. And, the functional (function) program for implementing the method, codes, and code segments can be easily inferred by programmers skilled in the art to which the invention pertains.

The present invention was describes above by referring to preferable embodiments, however, the present invention is not limited to the embodiments set forth and described above but can be modified and changed without departing from the spirit of the invention described in the claims by those skilled in the art.

What is claimed is:

1. A method for providing an application development environment comprising the steps of:
displaying a first window showing a connection between a plurality of pages that make up an application; and
displaying a second window showing a connection relationship among a plurality of components with respect to any one of the plurality of the pages,
wherein a first component including event information and a second component including action information are connected in the second window.

2. The method of claim 1, wherein the step of displaying the second window comprises a step of displaying the connection relationship between the event information and the action information

3. The method of claim 1, wherein the event information includes a plurality of the event items, and at least one of the plurality of event items is connected to the second component.

4. The method of claim 3, wherein the action information includes a plurality of action items, and at least one of the plurality of event items is connected with any one of the plurality of action items.

5. The method of claim 1, wherein the first window displayed shows connection relationship between the plurality of pages with directional image objects.

6. The method of claim 5, wherein the connection relationship between the plurality of pages is modified by changing the form of or deleting the image objects.

7. The method of claim 1, wherein the method further comprises a step of displaying detailed information of a specific page of the plurality of pages, and the detailed information includes identification information of the components included in the specific page and the attribute information of the selected component of the specific page.

8. The method of claim 7, wherein the attribute information comprises at least one of the basic information, data connection information, style information, and event information for the selected component.

9. The method of claim 1, wherein the second window displayed expresses the connection relationship between the plurality of pages with directional image objects, and connection relationship can be changed by changing or deleting the image objects.

10. The method of claim 1, further comprising the step of displaying a structural window showing the relationship between the action information and the second component.

11. An application development environment providing apparatus comprising:
a display unit displaying a first window showing connection relationship between a plurality of pages that make up an application, and a second window showing connection relationship between a plurality of components of any one of the plurality of pages; and
a control unit for connecting a first component including event information and a second component including action information in the second window.

12. The apparatus of claim 11, wherein the control unit controls the display unit to display the connection relationship between the event information and action information.

13. The apparatus of claim 11, wherein the event information includes a plurality of event items, and at least one of the plurality of the event items is connected to the second component.

14. The apparatus of claim 11, wherein the action information includes a plurality of action items, and at least one of the plurality of event items is connected with any one of the plurality of action items.

15. The apparatus of claim 11, wherein the first window displayed expresses the connection relationship between the plurality of pages with directional image objects.

16. A method for providing application development environment comprising the steps of:
displaying at least one component defined in an intermediate language on a window;
generating a first code composed of the intermediate language depending on the event or action assigned to the component; and
converting the first code to a second code corresponding with the target platform.

17. The method of claim 16, wherein the converting step further comprise the step of:
displaying selection window for selecting the target platform; and converting the first code to the second code corresponding with the target platform according to the target platform selected in the selection window.

18. The method of claim 16, further comprising a step of selecting the format of the converted second code, and the format is any one of a first format which can be installed in the terminal driven by the target platform or a second format which can be driven in the terminal driven by the target platform.

19. The method of claim 16, wherein the intermediate language is generated on the basis of the events designated among a plurality of components or window for the connection relationship among the actions.

20. The method of claim 16, wherein the intermediate language comprises a plurality of element codes expressing the components and the events or actions assigned to the components.

21. The method of claim 16, wherein the component comprises at least one of visual components, container components, collection components non-visual components.

22. The method of claim 16, wherein the intermediate language includes information on the relative arrangement between the components.

23. The method of claim 22, wherein the conversion step further comprise the steps of:
identifying the resolution information of the terminal in which the target platform is driven; determining the layout of the components on the basis of the resolution information and the layout information; and converting the first code to the second code according to the determined layout.

24. The method of claim 22, wherein the arrangement information is determined by the layout of at least one component displayed on the window.

25. A recording medium for recording a software program designed to execute the method described in any one of the claims 1 through 9 and claims 16 through 24.

26. An application development environment providing apparatus comprising:
a display unit for displaying at least one component defined in an intermediate language on a window;
an intermediate language generator for generating a first code composed of the intermediate language according to the event or action that is specified in the component; and
a converter converting the first code to a second code corresponding with a target platform.

27. The apparatus of claim 26, wherein the display unit displays a selection window for selecting the target platform, and the conversion unit converts the first code to the second code corresponding to the target platform selected in the selection window.

28. The apparatus of claim 26, wherein the display unit displays a selection window for selecting a format of the second code, and the selection window included a first format which can be installed in a terminal driven by the target platform and a second formation which can be driven in the target platform.

29. The apparatus of claim 26, wherein the intermediate language comprises a plurality of elements expressing the component and the events or actions assigned to the component.

30. The apparatus of claim 26, wherein the component comprises at least one of visual components, container components, collection components and non-visual components.

31. The apparatus of claim 26, wherein the intermediate language information includes relative arrangement information between the components, and the converter identifies the resolution information of the terminal in which the target platform is driven, determines the layout of the components on the basis of the resolution information and the arrangement information, and converts the first code to second code according to the determined layout.

32. The apparatus of claim 26, wherein the arrangement information is specified by the arrangement of at least one component displayed on the window.
